(19) United States
(12) Patent Application Publication
(10) Pub. No.: US 2004/0033806 A1
(43) Pub. Date: Feb. 19, 2004

(54) Packet data traffic management system for mobile data networks

(75) Inventors: Yoaz Daniel, Haifa (IL); Aharon Satt, Haifa (IL)

Correspondence Address: POLSINELLI SHALTON & WELTE, P.C., 700 W. 47TH STREET, SUITE 1000, KANSAS CITY, MO, 64112-1802, US

(73) Assignee: CellGlide Technologies Corp.

(21) Appl. No.: 10/222,489

(22) Filed: Aug. 16, 2002

(51) Int. Cl. H04Q 7/20

(52) U.S. Cl. 455/450; 455/423

(57) ABSTRACT

Systems and methods for dynamically managing data traffic in cellular networks are disclosed. These systems and methods conduct management of the data traffic in the form of: 1. service management, such as service provisioning and service level tuning and monitoring; 2. monitoring and controlling resources, such as bandwidth and delay; and 3. management of packet flows traffic. In doing so, there are provided methods for dynamically and automatically (continuously) adjusting the bandwidth and delay in individual shared access media or cells “on the fly”, to optimize user experience, usage and packet transmissions in the network.

### TECHNICAL FIELD

The present invention is directed to quality of service (QoS) management in data networks, and in particular, cellular networks.

### BACKGROUND

Cellular data networks including wired and wireless networks are currently widely and extensively used. Such networks include cellular mobile data networks, fixed wireless data networks, satellite networks, and networks formed from multiple connected wireless local area networks (wireless LANs). In each case, the cellular data networks include at least one shared media or cell.

FIG. 1 shows an exemplary data network 20, where a core cellular network 22 communicates with an Internet Protocol (IP) network 24 and cells 26, that provide services to subscribers 30, typically over radio channels 32. The IP network 24 connects with the core cellular network 22 over lines 34 or the like, and defines the “IP side” of the data network. The core cellular network 22 connects with cells 26 (although two are shown, this is exemplary only) over lines 36 or the like, and defines the “cellular side” of the network.

Presently, available bandwidth for transmissions through the cells 26 is limited technically, by physics, and legally, by regulations. Consequentially, congestion of the cells 26 occurs frequently, resulting in partial or total loss of data and large delays in data transfer on the route from the IP network 24 to the subscribers 30. This results in low service levels for the subscribers 30.

Contemporary systems are typically unmanaged, in the sense that neither monitoring nor control over the data traffic through the network can be preformed continuously. A few partial solutions have been proposed, but to date, they are incomplete and exhibit substantial drawbacks.

One solution involves placement of a traffic shaper along the communication line 34 on the IP side of the network 20, between the IP network 24 and the core cellular network 22. This solution is extremely partial, as it is limited only to smoothing traffic peaks. It does not provide any additional traffic control.

Another proposed solution manages bandwidth at the cellular side of the network 20. This solution involves placing a traffic shaper along the line 36, that connects the cells 26 and the core cellular network 22, where the core cellular network consists of any combination of switches, gateways, routers, servers, controllers, links and pipes, and the like. This proposed solution is highly inefficient due to highly complex protocol structures on the cellular side of the network, that are incompatible, with current IP based traffic shapers. Moreover, similar to the aforementioned solution, this traffic shaping mechanism performs only limited management of the traffic.

Both of these proposed solutions do not enable management of the data network in the sense of managing level of service. They require manual configuration of traffic shapers, which is work intensive and highly technical, and does not provide the means or terms of applying any given level of service policy.

### SUMMARY

The present invention improves on the contemporary art by providing systems and methods for dynamically managing data traffic in cellular networks. This management includes the following: 1. service management, such as service provisioning and service level tuning and monitoring; 2. monitoring and controlling resources, such as bandwidth and delay; and 3. management of packet flows traffic. In doing so, there is provided a method for dynamically and automatically (continuously) adjusting the bandwidth and delay in individual shared access media or cells “on the fly”, to optimize user experience, usage and packet transmissions in the network.

In dynamically managing resources, parameters closer to those associated with user experiences are employed. The invention is scalable, and can accommodate large networks with large numbers, for example, with thousands of shared access media or cells. Embodiments of the invention are directed to monitoring and controlling service levels (also referred to as level or levels of service) in individual shared access media or cells.

An embodiment of the present invention is directed to a method for allocating resources in a cellular network comprising, monitoring the cellular network, this monitoring comprising, continuously measuring approximate available bandwidth (or capacity) within at least one shared media (or cell) in the cellular network, and continuously measuring the demand for bandwidth within the at least one shared media, for at least two service classes. Bandwidth allocations are automatically changed for each of the at least two service classes in accordance with at least one value from the continuously measured approximate available bandwidth and at least one value from the continuously measured demand for bandwidth. Bandwidth allocations are typically in the form of guaranteed and overall bandwidth portions, with changes to the guaranteed and overall portions being either by, setting (or resetting) the guaranteed portions and their corresponding overall portions, or tuning the guaranteed and overall portions.

Another embodiment of the invention is directed to an apparatus for allocating resources in at least one cellular network. This apparatus includes a storage medium and a processor, e.g., a microprocessor. The processor is programmed to, monitor the cellular network, including continuously measuring approximate available bandwidth within at least one shared media (or cell) in the cellular network, and continuously measuring the demand for bandwidth within the at least one shared media, for at least two service classes. The processor is also programmed to automatically change bandwidth allocations for each of the at least two service classes in accordance with at least one value from the continuously measured approximate available bandwidth and at least one value from the continuously measured demand for bandwidth.

Another embodiment of the invention is directed to a programmable storage device readable by a machine, tangibly embodying a program of instructions executable by a machine to perform method steps for providing resource allocations in a cellular network, the method steps selectively executed during the time when the program of instructions is executed on the machine, comprising, monitoring the cellular network. This monitoring includes, continuously measuring approximate available bandwidth within at least one shared media in the cellular network, continuously measuring the demand for bandwidth within the at least one shared media (or cell), for at least two service classes. The method steps also include automatically changing bandwidth allocations for each of the at least two service classes in accordance with at least one value from the continuously measured approximate available bandwidth and at least one value from the continuously measured demand for bandwidth.

There is disclosed a method for managing data traffic in cellular networks, with the cellular networks having at least one cell. This method includes, analyzing Quality of Service (QoS) parameters from at least one flow, analyzing the at least one flow based on said QoS parameters to determine the minimum amount of resources for accommodating the at least one flow in the at least one cell, monitoring the at least one cell for available resources, determining the minimum amount of resources necessary for flows already accommodated in the at least one cell, determining the amount of available resources for the at least one flow based on the monitored resources of the at least one cell and the determined minimum amount of resources for the already accommodated flows in the at least one cell. Additionally, if the determined minimum amount of resources for accommodating the at least one flow in the at least one cell is at least equal to the determined amount of available resources for accommodating the at least one flow in the at least one cell, the at least one flow is admitted into the at least one cell.

There is also disclosed a server for managing data traffic in cellular networks. The server includes a processor (for example, as microprocessor) programmed to: analyze Quality of Service (QoS) parameters from at least one flow, analyze the at least one flow based on the QoS parameters to determine the minimum amount of resources for accommodating the at least one flow in the at least one cell, monitor the at least one cell for available resources, determine the minimum amount of resources necessary for flows already accommodated in the at least one cell, and determine the amount of available resources for the at least one flow, based on the monitored resources of the at least one cell and the determined minimum amount of resources for the already accommodated flows in the at least one cell. The at least one flow will be admitted into the at least one cell if the determined minimum amount of resources for accommodating the at least one flow in the at least one cell is at least equal to the determined amount of available resources for accommodating the at least one flow in said at least one cell.

Also disclosed is a programmable storage device readable by a machine, tangibly embodying a program of instructions executable by a machine to perform method steps for controlling traffic in a data network, the method steps selectively executed during the time when the program of instructions is executed on the machine. These steps include: analyzing Quality of Service (QoS) parameters from at least one flow, analyzing the at least one flow based on the QoS parameters to determine the minimum amount of resources for accommodating the at least one flow in the at least one cell, monitoring the at least one cell for available resources, determining the minimum amount of resources necessary for flows already accommodated in the at least one cell, and determining the amount of available resources for the at least one flow, based on the monitored resources of the at least one cell and the determined minimum amount of resources for the already accommodated flows in the at least one cell.

There is disclosed a method for managing resources in cellular networks. This method includes, monitoring resources of at least one cell, determining demand for resources for each of at least two service classes associated with the at least one cell, and allocating resources for each of the service classes based on the monitored cell resources and the determined demand for resources.

Also disclosed is a server for managing resources in cellular networks. The server includes a processor (for example, a microprocessor) programmed to: monitor resources of at least one cell, determine demand for resources for each of at least two service classes associated with the at least one cell, and allocate resources for each of the service classes based on the monitored cell resources and the determined demand for resources.

Also disclosed is a programmable storage device readable by a machine, tangibly embodying a program of instructions executable by a machine to perform method steps for controlling traffic in a data network, the method steps selectively executed during the time when the program of instructions is executed on the machine. The method includes monitoring resources of at least one cell, determining demand for resources for each of at least two service classes associated with the at least one cell, and allocating resources for each of the service classes based on the monitored cell resources and the determined demand for resources.

There is disclosed a method for controlling Quality of Service (QoS) in cellular networks. The method includes, monitoring resources of at least one cell of the cellular network, determining demand for resources for each of at least two service classes associated with the at least one cell, and controlling the QoS of each of the service classes based on the monitored cell resources and the determined demand for resources.

Also disclosed is a server for controlling Quality of Service (QoS) in cellular networks. The server includes a processor (for example, a microprocessor) programmed to: monitor resources of at least one cell, determine demand for resources for each of at least two service classes associated with the at least one cell, and control the QoS of each of the service classes based on the monitored cell resources and the determined demand for resources.

Also disclosed is a programmable storage device readable by a machine, tangibly embodying a program of instructions executable by a machine to perform method steps for controlling traffic in a data network, the method steps selectively executed during the time when the program of instructions is executed on the machine. The method steps include: monitoring resources of at least one cell, determining demand for resources for each of at least two service classes associated with the at least one cell, and controlling the QoS of each of the service classes based on the monitored cell resources and the determined demand for resources.

There is disclosed a method for managing data traffic in cellular networks. The method includes analyzing Quality of Service (QoS) parameters for each of the flows accommodated by at least one cell in the cellular network, determining the minimum amount of resources for keeping each flow accommodated by the at least one flow, monitoring the at least one cell for available resources, and determining if at least one specific flow from the flows accommodated by the at least one cell is dropped.

Also disclosed is a server for managing data traffic in cellular networks, having at least one cell therein. This server includes a processor programmed to: analyze Quality of Service (QoS) parameters for each of the flows accommodated by at least one cell, determine the minimum amount of resources for keeping each flow accommodated by the at least one flow, monitor the at least one cell for available resources; and determine if at least one specific flow from the flows accommodated by the at least one cell is dropped.

Also disclosed is a programmable storage device readable by a machine, tangibly embodying a program of instructions executable by a machine to perform method steps for controlling traffic in a data network, the method steps selectively executed during the time when the program of instructions is executed on the machine. The method steps include: analyzing Quality of Service (QoS) parameters for each of the flows accommodated by at least one cell, determining the minimum amount of resources for keeping each flow accommodated by the at least one flow, monitoring the at least one cell for available resources; and determining if at least one specific flow from the flows accommodated by the at least one cell is dropped.

There is disclosed a method for managing data traffic in cellular networks, having at least one cell (shared media). This method includes: analyzing Quality of Service (QoS) parameters for each of the flows admitted to at least one cell, analyzing QoS for at least one flow waiting for admission to the at least one cell, determining the minimum amount of resources to keep each admitted flow accommodated by the at least one cell, determining the minimum amount of resources to admit the at least one flow waiting for admission to the at least one cell, monitoring the at least one cell for available resources; and determining if at least one specific flow from the flows accommodated by the at least one cell is dropped and the at least one flow waiting for admission is to be admitted.

Also disclosed is a server for analyzing Quality of Service (QoS) parameters for each of the flows accommodated by at least one cell. The server includes a processor. This processor is programmed to: determine the minimum amount of resources for keeping each flow accommodated by the at least one flow, monitor the at least one cell for available resources, and determine if at least one specific flow from the flows accommodated by the at least one cell is dropped.

Also disclosed is a programmable storage device readable by a machine, tangibly embodying a program of instructions executable by a machine to perform method steps for controlling traffic in a data network, the method steps selectively executed during the time when the program of instructions is executed on said machine. The method steps include: analyzing Quality of Service (QoS) parameters for each of the flows admitted to at least one cell, analyzing QoS for at least one flow waiting for admission to the at least one cell, determining the minimum amount of resources to keep each admitted flow accommodated by the at least one cell, determining the minimum amount of resources to admit the at least one flow waiting for admission to the at least one cell; monitoring the at least one cell for available resources, and determining if at least one specific flow from the flows accommodated by the at least one cell is dropped and the at least one flow waiting for admission is to be admitted.

### BRIEF DESCRIPTION OF THE DRAWINGS

Attention is now directed to the attached drawings, wherein like reference numerals or characters indicate corresponding or the like components. In the drawings:

FIG. 1 is a diagram showing a contemporary network;

FIG. 2 is a diagram showing an embodiment of the present invention;

FIG. 3 is a schematic diagram of levels of the present invention;

FIG. 4A is a flow diagram of an exemplary process in accordance with a portion of the upper level, or service management level, of FIG. 3;

FIG. 4B is a diagram showing tables used in the process detailed in FIG. 4A;

FIG. 5 is a flow diagram of an exemplary process in accordance with a portion of the upper level, or service management level, of FIG. 3;

FIG. 6 is a diagram showing a screenshot of an exemplary graphical user interface in accordance with an embodiment of the present invention;

FIG. 7 is a flow diagram of an exemplary process in accordance with the intermediate level, or resource management level, of FIG. 3;

FIG. 8 is a flow diagram of an exemplary process in accordance with the lower level, or flow management level, of FIG. 3;

FIG. 9 is a schematic diagram of an exemplary queuing device in accordance with an embodiment of the present invention;

FIG. 10 is a diagram of an alternate embodiment of the present invention;

FIG. 11 is a flow diagram of a process employed with the embodiment of FIG. 10; and

FIG. 12 is a schematic diagram of an alternate exemplary queuing device in accordance with an alternate embodiment of the present invention.

### DETAILED DESCRIPTION OF THE DRAWINGS

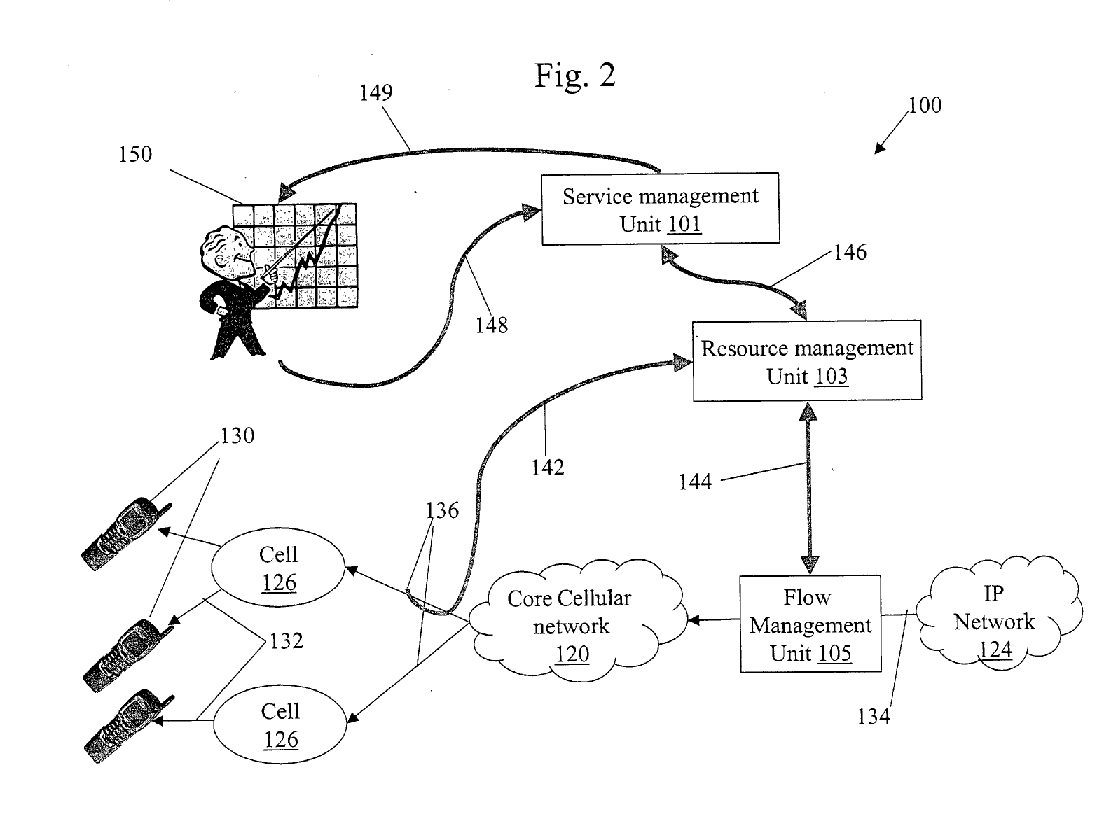

FIG. 2 shows an exemplary system 100, for performing the invention. The system 100 includes three units, 101, 103, 105 that perform the invention, typically in software, hardware or combinations thereof. These units include: a Service Management Unit 101, typically a server or the like; a Resource Management Unit 103, typically a server or the like; and a Flow Management Unit 105, typically a server, a switch, a router or the like. These units 101, 103, 105 typically include, for example, components such as processors (microprocessors), network interface media, storage media, etc.

The Service Management Unit 101 is configured for receiving inputted data from an external source, such as that inputted by a system administrator 150, or other data input unit (automatic or human controlled), other person, or the like (hereafter a “system administrator” as representative of the above), as per arrows 148 and 149. It is also in communication with the Resource Management Unit 103 as per arrow 146, representative, for example, of a physical connection or line. The Resource Management Unit 103 is also in connection with the Flow Management Unit 105 as per arrow 144, representative, for example, of a physical connection or line, and lines, links or pipes 136 as per arrow 142, for monitoring available cell resources or cell capacity. While monitoring signaling along lines 136 is shown, this is exemplary only, and monitoring can be performed in servers or controllers associated with the cells 126, or within the core cellular network 120, or any other place where measurements of cell capacity may be obtained continuously and/or “on the fly”.

The Flow Management Unit 105 sits on, or along, the line 134. It monitors and controls the data packet traffic while on the route from the IP network 124 to subscribers 130, through the core cellular network 120, lines 136, cells 126 and radio channels 132.

The Service Management Unit 101, the Resource Management Unit 103 and the Flow Management Unit 105 typically operate concurrently to provide a top-down management solution, that is performed continuously and on the fly. The solution is a top-down solution in that a system administrator 150 may control the Service Management Unit 103, by inputting data corresponding to service decisions and policies for the unit 101, in direction of the arrow 148. These decisions and policies regarding specific data services are than passed downward, in the direction of the arrow 146, to the Resource Management Unit 103. The Resource Management Unit 103 in turn processes these policies together with available cellular resources and inputs received in direction of the arrow 142, along with IP side demand inputs in direction of the arrow 144. This processing yields output corresponding to dynamic resource allocation decisions reflecting the service policies and decisions of the administrator 150. These allocation decisions are then passed downward in direction of the arrow 144 to the Flow Management Unit 105, for real time implementation. The Flow Management Unit 105 implements these decisions by allocating resources (as detailed below), such as bandwidth and delay, to all flows pertaining to the administrator 150 defined services (as inputted and received in the Service Management Unit 101).

The Flow Management Unit 105 also monitors the traffic flow that it controls over line 134, and passes the gathered data upward to the Resource Management Unit 103, in direction of the arrow 144. The Resource Management Unit 103 processes the raw data into quality of service (QoS) statistics detailed below, to be passed upward to the Service Management Unit 101, in direction of the arrow 146. The Service Management Unit 103 collects and aggregates these QoS statistics over long periods of time and multitudes of cells. These aggregated statistics, as well as statistics for individual cells and short time periods, can than be accessed externally, with data flow in the direction of arrow 149, for example by the system administrator 150 for the purpose of reviewing the results of decisions and policies taken. For example, the system administrator 150 can then, based on these reviewed results, enter inputs to the system for receipt by the Service Management Unit 103, to tune or change any (including his own) prior decisions “on the fly”, with data flow in the direction of arrow 148 (as detailed above).

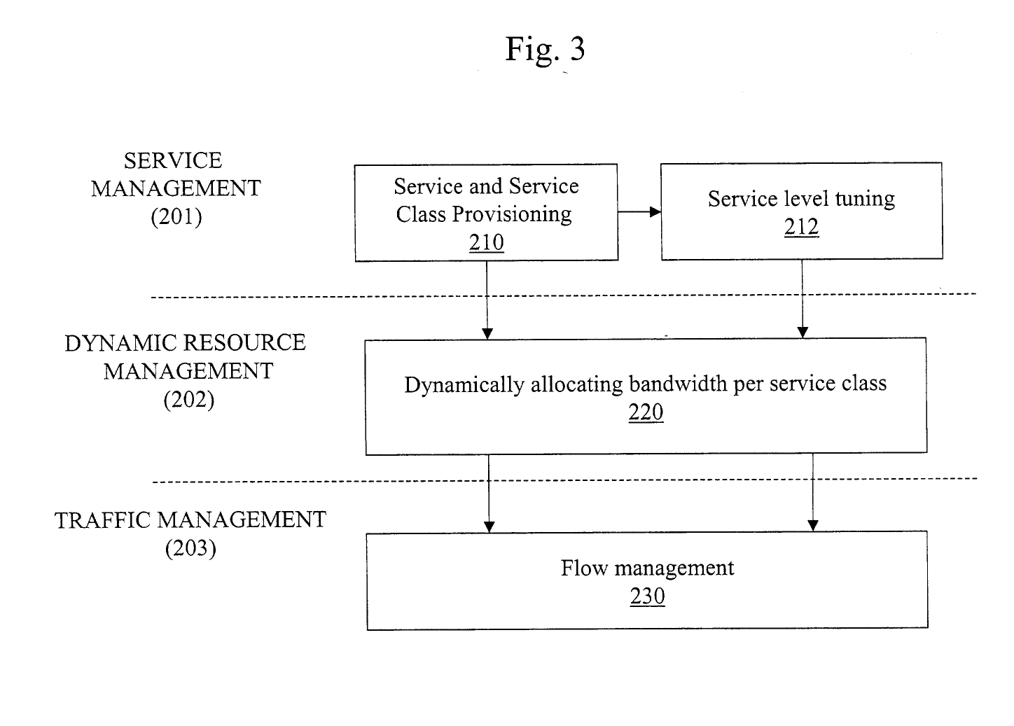

FIG. 3 is a diagram detailing an embodiment of the invention as divided into levels, 201, 202 and 203. For example, there is a service management or upper level 201, including the processes of Service and Service Class provisioning, at block 210, and Service Level Tuning, at block 212. This level 201 is over a Dynamic Resource Management Level 202, that includes the processes of Dynamically Allocating Bandwidth Per Service Class, at block 220. This intermediate level 202 is over a Traffic Management or base level 203, that includes the processes of Flow Management at block 230.

Each of the aforementioned levels 201-203, controls the levels beneath it, and monitors those levels. The hierarchy indicated by the direction of the arrows in this Figure. The monitored levels then report, by sending signals or the like, to the upper levels. For example, Service Management Level 201 controls and monitors Dynamic Resource Management or intermediate level 202, with this level reporting back to the Service management level 201. Similarly, Dynamic Resource or Intermediate Level 202 controls and monitors the Traffic Management or Base level 203, with this level 203 reporting back to the Dynamic Resource or Intermediate level 202.

These levels 201-203 are all directed to enabling a complete management solution to data traffic in cellular networks. They are useful for controlling such packet data traffic at all levels. For example, at the lowest level, management is by the Flow Management Unit 105 (FIG. 2), and the data traffic is composed of data packets. At the upper level, management is by the Service Management Unit 101, and data traffic is viewed as various services delivered to various subscribers or subscribers groups.

In order to allow for a complete or total management solution, the difference between individual data packets and general services and service types, requires understanding of data packet flows and service classes.

Data packet flows, or flows, are sequences of one or more packets with common attributes, typically identified by the packet headers, for example, as having common source and common destination IP addresses and common source and common destination ports of either TCP or UDP. In this example, flow is started upon initiating a TCP connection or receiving the first packet, and ended, or terminated, by tear-down of the TCP connection or following certain time-out from the last received packet.

A service class is a category of flows used to maintain levels of service for a certain group or type of flows. Specific flows require specific resource treatment to yield specific levels of service. Flows differ from each other in the manner in which they utilize resources available to them, as well as in the amount of resources they require for achieving a specific level of service. Service classes are utilized as categories of flows, all of which require the same type of resource treatment and allocation.

The concept of service classes enables a system administrator to configure desired levels of service, in accordance with his per-service policies, either at the network level, the sub-network level, the cell level, or combinations thereof. This pre-configuration takes place in the Service Management Unit 101 (FIG. 2) at the Service Management Level 201.

For these desired levels of service to be realized, two additional management levels are typically applied: a flow management level, or traffic management level, 203; and a resource management level, 202.

The flow management level 203, manages the individual flows on route to the subscribers, in real time. It attempts to provide each flow with its appropriate level of service, as designated by the service management level 201. The resource management level 202 manages each cell's resources, trying to ensure that each service class receives its designated level of service, by allocating the cell's resources to the cell's requisite service classes.

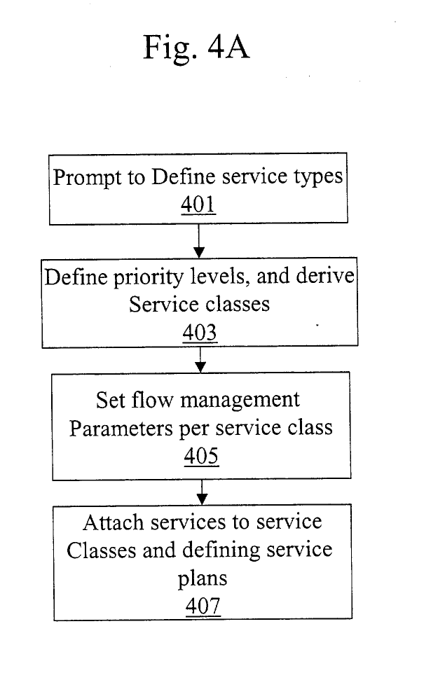

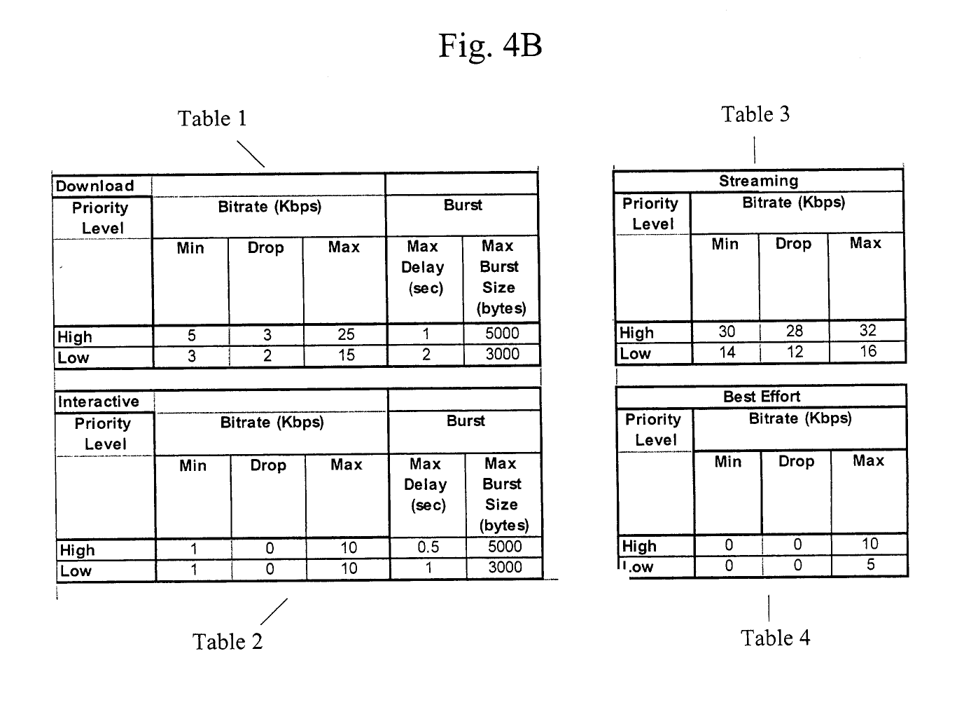

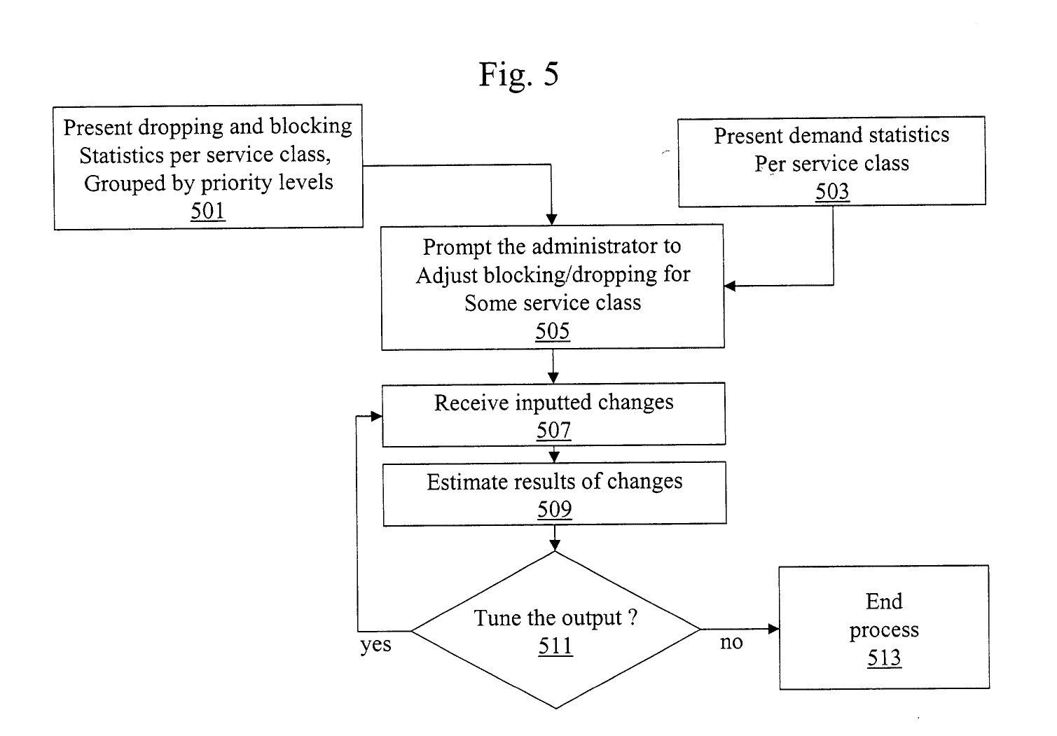

Turning also to FIGS. 4A, 4B, and 5, attention is directed to the Service Management or upper layer 201. This level 201 is for receiving and processing a system administrator's input and reporting output interactively and “on the fly”. Input is directed to, for example, priorities and preferences, levels of service, quality of service (QoS), control of resources, etc. The output is directed to reporting results, including empirical results, for example, QoS, levels of service, etc. This level 201 is interactive and, can be managed “on the fly”, by entering the desired input. This level 201, as noted above, is divided into the processes of service provisioning, block 210 and service level tuning, at block 212.

Service provisioning, at block 210, enables the system administrator to define service level parameters for guaranteeing the level of service (service level or the like) for each flow within a service class he wishes to define. Thus, service provisioning 210 is aimed at configuring per-flow level of service parameters, to be applied by the Flow Management Unit 103 (FIG. 2), at the Flow Management Level 203 on the individual flows on route to the subscribers 130.

FIG. 4A shows an exemplary process of service provisioning. This process is aimed at configuring potential service level parameters for each flow that can be transmitted to the subscribers. This process attempts to ensure that once a data packet flow is designated to pass from a server to a subscriber, it passes with the desired level of service. The service level parameters may also be used for flow admission control: upon a specific flow entering the system, that is reaching the Flow Management Unit 103 (FIG. 2), a decision is made in real-time as to whether sufficient resources exist to enable transmission of that flow within the required level of service. Service provisioning results in a determination of resources sufficient to enable levels of service for each type of flow. A flow which has sufficient resources to enable its transmission is admitted to the cell, thereby it is accommodated by the cell. Service levels are, for example, established by the system administrator.

The process of service provisioning is typically based on interaction with a system administrator (such as 150 of FIG. 2) enabling him to translate desired quality of service associated with service characteristics into measurable and enforceable parameters and decisions. This interaction between the Service Management Unit 101 and the system administrator 150 may be by use of a computerized user interface, a database, an input-output system or the like.

Alternately, service provisioning defaults, detailed below, can be programmed into the Service Management Unit 101, such that interactions with a system administrator 150 are not required for this process. Typically, the system administrator is presented with these defaults as outputs and may override them by entering the desired input.

The process of service provisioning begins at block 401 where a system administrator is prompted by the Service Management Unit 101 (FIG. 2) to define service types. A service type is a category of services, all of which require the same qualitative treatment. The system does not require any response(s) to the prompt, and thus, should the prompt go unanswered for a certain time, for example one hour, the process will move to block 403. Note that at block 401 the administrator is not required to take any quantitative decisions, as this stage functions as a preparatory conceptual stage. The administrator may define service types himself, or except the systems defaults, which can include, for example, the following four service types:

The streaming service type. This type includes all services associated with a typical packet flow which would require a nearly constant bit-rate throughout its duration. This type includes services such as streaming video services, voice streaming for mail services, streaming audio services, etc.

The downloading service type. This type includes all services a typical packet flow of which would require an average bit-rate of some magnitude, as calculated over the flow duration. This type include services such as file transfer services, electronic mail services, etc.

The interactive service type. This service type includes services, typically characterized by short data bursts serving interactive requests and answers, referred to as messages, requiring low latency responses. This type may include services such as chat services, mobile transaction services, etc.

The best effort service type. This includes services the administrator does not assign any specialized treatment to.

Service types may be extended to accommodate a changing behavior of flows over time, and the corresponding changing requirements for resource allocation. For instance, download service type may support interactive-oriented periods within each flow, similar to interactive service type, as detailed below. An example for such service is Web browsing or WAP service, which typically consists of interactive menu-driven messages, requiring low latency, followed by larger object downloads, requiring certain average bit-rate.

With service types defined, the process continues to block 403 where priority levels are defined, and consequently service classes are determined. A service class is a category of all flows that receive similar resource allocations, and is defined to be the category of flows sharing the same service type and priority levels.

There are two types of priority levels: absolute priority levels and relative priority levels. Both types of priority levels are defined to enable the administrator to differentiate between different service classes in terms of different resource allocation priorities.

Absolute priority levels are defined to enable the administrator to set service classes, which receive their determined level of service prior to other service classes. By definition, each absolute priority level receives access to resources before all lower absolute priority levels. Relatively priority levels are defined to enable the administrator to set service classes, which potentially receive a larger relative portion of the available cell resources, if required according to the determined level of service, than other service classes of the same absolute priority.

As a result, a higher priority level service class, either absolute or relative, typically has a higher quality of service, if the cell capacity, or available resources, is insufficient to accommodate all concurrent services. The system administrator may define as many or as few priority levels as desired.

By default, the number of service classes is determined by the number of service types multiplied by the number of absolute priority levels and by the number of relative priority levels. However, the system administrator may override this by defining different numbers of absolute and relative priority levels for different service types. In this case the number of service classes is the sum of all the combinations of absolute and relative priority levels, as defined across all service types.

Alternatively the system administrator may accept the system defaults, which, for example, might be defined by one absolute level and three relative levels. The relative levels may be, for example: 1. “gold”, the highest level; 2. “silver”, the intermediate level; and 3. “bronze”, the lowest level. Accordingly, for example, the exemplary defaults create twelve exemplary service classes: streaming gold, streaming silver, streaming bronze, download gold, download silver, download bronze, WAP gold, WAP silver, WAP bronze, web browsing gold, web browsing silver and web browsing bronze.

Operation now passes to block 405 where the system administrator is prompted to define specific quantitative treatment to be assigned to each flow arriving to its requisite service class as defined above. For example, the system administrator is prompted to set flow management parameters per service class. This is typically in accordance with the default Tables 1-4 of FIG. 4B. Although Tables 1-4 are supplied with default values, they may be overridden by the system administrator. If no such overriding is performed the default values in Tables 1-4 are used by the system.

The aforementioned parameters listed in Tables 1-4 are now explained in greater detail. By default, these parameters include the following exemplary parameters:

The minimum, or “min”, bit-rate is a portion of bandwidth guaranteed to a flow throughout the time of its passage thorough the system. A flow is not admitted for transmission if available resources, i.e., bandwidth, are less than the necessary bandwidth for accommodating this flow. If the flow is admitted, it will receive at least this amount of bandwidth resources as a minimum, throughout the period of its existence.

The maximum, or “max”, bit-rate per flow is a definition of the maximal amount of bandwidth the flow is permitted to use. At all times of its existence the flow does not reach up above this amount of bandwidth.

The drop bit-rate is the minimal amount of bandwidth resources allowing continued existence of the flow. If available resources drop below this level, then the service level becomes unacceptable, and the corresponding flows may be dropped. Continued transmission of these below drop bit-rate flows could waste the system resources, typically by overloading one or more buffers with unusable packets, that do not provide sufficient service levels in terms of delay and/or bit-rate.

The above three parameters, minimum, maximum and drop bit-rate, are by default, available to all service classes. Service classes for which bursts of data flows requiring low latency responses are expected, additional burst parameters may be defined, as for example for “download” service classes, Table 1, and “interactive” service classes, Table 2. Data packet flows categorized to these service classes are defined as “burstable flows”. In order to support changing behavior of flows over time, the duration period of a burstable flow can be divided to typical period types, where at each period the data demand and quality of service parameters are different. These time periods may include the following:

1. Idle periods, at which no data packets are delivered to the subscriber;

2. Interactive burst periods, at which short bursts of data requiring short latency responses occur; and

3. Download periods, at which amounts of data typically larger then the bursts are to be delivered to the subscriber, requiring average bit-rate for longer periods of time.

To enable quality of service management to flows exhibiting the above three typical periods through the flows' duration, the system defines additional parameters. These parameters typically include the following:

The maximum delay, or “max delay” is the maximal latency time for a response to an interactive request, occurring in an interactive data burst period (message).

The burst size determines the amount of data expected to arrive at a “burst” of the flow; that is the amount of data expected to arrive requiring a latency time lower than the maximum delay. As a default, the system would identify the first “burst size” of data arriving following an idle period of a burstable flow, as a burst, and attempt to deliver this amount of data with latency smaller than the maximum delay.

The mechanism of burstable flows may be extended such that the transition between interactive burst period and download period or idle period is continuous, or in multiple incremental steps, rather than in one immediate step. The corresponding allocated resources change continuously, or in multiple incremental steps, from resources that aim at supporting maximum response delay to resources supporting average or minimum bit-rate.

With flow management parameters set, at block 405, the process continues in block 407. Here, input is received, typically from the system administrator; based on this input, service classification rules are determined. The service classification rules attach specific services to the requisite service classes. However, absent input, the defaults service classification rules are processed, these defaults for example being attaching all non attached services to the low best effort service class.

Identifying services is based, among other parameters as detailed below, on service categories. The service categories, which are used to identify services and define service classification rules, are identifiable at the level of flow management 203 (FIG. 3), so that each flow reaching the Flow Management Unit 105 (FIG. 2) can be identified with a service, and thus, with a corresponding service class via service classification rules. These service categories may include the following categories, made available by reading Internet Protocol (IP) packet headers and upper layer protocol information:

Transfer protocol type. Including Transmission Control Protocol (TCP) and User Datagram Protocol (UDP), identifiable by classification of Layers 3-4 IP headers (of standard IP headers).

Application type. Identifiable by classification of Layer 3-7 headers. Exemplary application types include e-mail services, streaming multimedia services, streaming voice services, multimedia downloading services, file transfer, etc.

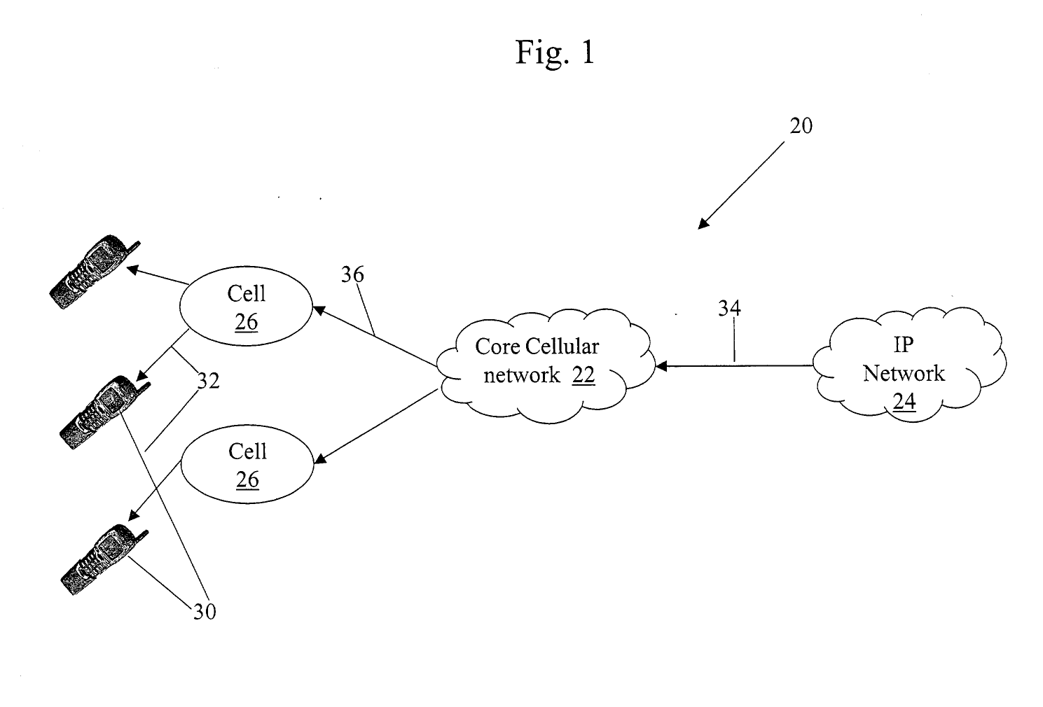

Host type. Identifiable, for example, by matching of source (host) IP addresses with predetermined lists of IP addresses supplied by the system administrator or alternatively, for example, read from networks such as the Internet or the core cellular network 22 (FIG. 1).

Additional service categories are made available by analyzing the destination IP address available in each IP data packet header, and by matching this IP address information with specific cellular network information. Service categories available by this analysis include the following:

Subscriber type. Identifiable by matching destination IP address to cellular subscriber identification, for example, matching of IP address to International Mobile Subscriber Identification (IMSI) of a subscriber in cellular General Packet Radio Services (GPRS) mobile networks.

Terminal type. Identifiable by matching destination IP addresses to cellular subscriber information indicating the type of device the subscriber is using. For example, in a GPRS network, this can be done by identifying IP destination addresses with corresponding International Mobile Equipment Identity (IMEI) identifications of mobile devices.

Geographic location. Identifiable by association of destination IP addresses with the cell or cells the cellular subscriber receives data through.

Cell type. Identifiable by association of destination IP addresses with the cell or cells the cellular subscriber receives data through.

In addition, the system is automatically aware of global parameters such as the current date, day of the week, hour of day, etc.

In block 407, the service classification rules are now determined. The service classification rules are used to map flows, based on service categories and global parameters such as those mentioned above, for the service classes.

A flow may be classified and mapped to a service class on entering to the system and reaching the Flow Management Unit 105 (FIG. 2), and remain attached to the requisite service class for its entire duration. Alternatively, flows may be monitored for any change in their service categories, and re-mapped to other service classes in the course of their existence.

On some cellular networks, such as Code Division Multiple Access (CDMA) networks, multiple cells may serve a single flow simultaneously (the “serving cells”), requiring separate resource allocation in each serving cell. In accordance with the disclosure herein, this situation may be supported, for example, by classifying and attaching the flow to multiple service classes, one service class per each serving cell. Resources are allocated to the flow separately in each serving cell through the requisite service class.

Typical service classification rules are set in accordance with the following example rule:

If (host=X and subscriber=Y and device=Z and date=T and time of day=T₂ And cell type=C_{type}) then (service class=W) (1)

Where,

X is a certain host or hosts identification or identifications (such as a list of IP addresses, or the like);

Y is a certain subscriber or subscribers identification or identifications (such as a list of IP addresses, IMSI identifications, or the like);

Z is a certain device type or types identifications (such as IMEI numbers, manufacturers' identification, etc.);

T is a certain list of date or dates at which the service plan should be applied;

T₂ is a certain hour of the day, or a list of such hours, at which this service plan should be applied;

C_{type} is a certain cell type or a list of cell types, at which this service plan should hold; and

W is a certain (unique) service class of the service classes defined above.

Defining service classification rules (one or more, covering all cases or only part of them) is optional, as the aforementioned system defaults are sufficient for proper operation of the system. As a default, no service classification rules are defined.

As the operation of block 407 is finished, the process is concluded. Service provisioning is now complete. As defined above, this defines the per flow quality of service parameters.

Referring specifically to FIGS. 3 and 5, service level tuning, at block 212, determines the overall level of service per service class. This process, as opposed to provisioning of individual services, is not aimed at guaranteeing service levels to specific flows, but rather assumes that each flow, once admitted, has an already established service level. This service level was determined according to the per-flow service level parameters of the flow's corresponding service class, where the corresponding service class was determined by the service classification rules.

The actual attained service levels of the service classes are monitored and controlled with two parameters for each service class: 1. blocking rate of a service class, which is the percentage of flows not admitted passage out of the totality of flows reaching the said service class over a period of time; and 2. dropping rate (also referred to as killing rate) of a service class, which is the percentage of flows whose passage was stopped in its midst, out of the totality of flows of that service class, over a period of time. Exemplary value for the period of time is one week. Service level tuning allows for the monitoring and controlling of these parameters per service class. Monitoring is interactive and “on the fly” and typically performed by the system administrator.

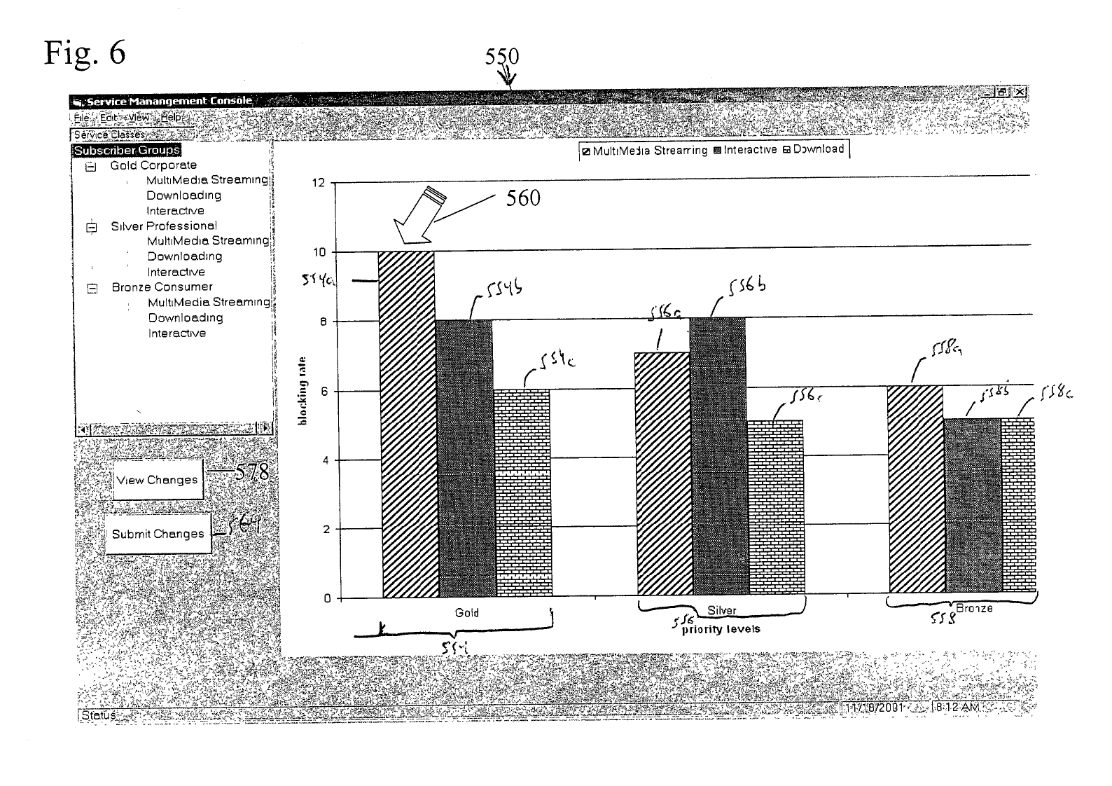

FIG. 5 shows an exemplary process of service level tuning. This process is suited for receiving input from a system administrator, and providing output, typically in the form of management tools, for controlling one or more quality of service (QoS) parameters. The input and output is typically provided in an interactive mode, and is typically represented in the form of a Graphical User Interface (GUI), for example, the GUI shown in FIG. 6.

The process begins by contemporaneously, and typically simultaneously, presenting the system administrator with two types of statistics: 1. blocking and dropping rates per service class, at block 501; and 2. demand per service class, at block 503, detailed below.

For example, the processes of block 501 and 503 can be applied on a per cell basis and then accumulated so as to represent the entire cellular network, or a specific portion of the entire cellular network. A portion of the cellular network is typically defined, for example, by accumulating statistics for all cells of a specific type, or for all cells in a specific geographical area, for example, all cells within a specific business district, etc.

The sub processes (operations) of blocks 501 and 503 are typically preformed in the Service Management Unit 101 (FIG. 2). These sub processes (of blocks 501 and 503) utilize statistics, that have been collected on a per cell basis, and were, for example, received as data sent from the Resource Management Unit 103 (FIG. 2). These statistics include the following three statistics, defined as follows:

1. b_{c,i}, the blocking rate of service class i at cell c. This is the percentage of flows of the service class i, that reached the cell c, but whose passage was not admitted through this cell. This may be for many reasons, but typically because the cell lacked sufficient resources to accommodate all of the flows belonging to service class i that reached the cell, over a period of time, for example, one week.

2. k_{c,i}, the dropping (or killing) rate of service class i at cell c. This is the percentage of flows of the service class i, that reached the cell c but whose passage through this cell c was terminated during passage through the cell c, over a period of time, for example, one week.

3. d_{c,i}, the demand of service class i at cell c. This is the average demand for resources, typically in terms of bit-rate, for service class i as calculated by the Resource Management Unit 103, and detailed below, over a period of time, for example, one week.

At block 501 the per cell statistics are processed into overall per service class statistics and outputted, for example, so as to be accessible externally, for example by a system administrator. This processing typically includes averaging, as, for example, in the following formulae:

$$\begin{matrix}{b}_{i} = \frac{{\sum }_{c = 0}^{N} {b}_{c , i} \cdot {d}_{c , i}}{{\sum }_{c = 0}^{N} {d}_{c , i}} & ( 2 ) \\ {k}_{i} = \frac{{\sum }_{c = 0}^{N} {k}_{c , i} \cdot {d}_{c , i}}{{\sum }_{c = 0}^{N} {d}_{c , i}} & ( 3 )\end{matrix}$$

where,

bᵢ is the overall blocking rate for service class i to be calculated;

kᵢ is the overall dropping rate for service class i to be calculated; and

N is the total number of cells in the network, or in a specific portion of the cellular network, the default being the total number of cells in the cellular network.

The results from Formulae (2) and (3) provide the overall blocking and dropping rates per service class over the entire cellular network or the specific portion of the network. These results are outputted, for example, so as to be accessible externally, for example by a system administrator. The operation of the sub-process of block 501 has now concluded.

At block 503 the demand per service class is outputted, for example, so as to be accessible externally, for example, by an administrator. By knowing the output values, the System Administrator could provide input to change the blocking and dropping rates for certain service classes. Accordingly, the demand presented shows the relative sizes of demands for resources for all service classes. This is achieved by summing the demand for each service class across all cells, as in, for example, the following formula:

$${d}_{i} = {\sum }_{c = 0}^{N} {d}_{c , i} \qquad ( 4 )$$

where,

dᵢ is the overall demand for service class i to be calculated.

With all of these statistics suitable for outputting, the process moves to block 505. Here, the system outputs prompts, where, for example, the System Administrator is prompted to reset goals in order to achieve newly desired statistical results.

For example, the present situation (blocking rates, dropping rates and demands), as reported from blocks 501 and 503, as well as the new goals (requested new values for the blocking rates and dropping rates) can be represented, on a graphical user interface (GUI), as shown by the screen shot 550 of FIG. 6. The GUI represented in FIG. 6 is exemplary, as the present situation may be outputted for external access, by any suitable input-out put device or form, such as for example, in a digital file format, in the form of tables, as command lines on a monitor, etc.

In the exemplary GUI of FIG. 6, service types (steaming, interactive and download, for example) are presented in various levels, for example three relative priority levels (detailed above), such as Gold 554, Silver 556 and Bronze 558, and a single absolute level. These levels 554, 556, 558 may be further divided into sublevels 554a-554c, 556a-556c and 558a-558c (corresponding to the service classes: streaming gold, streaming silver, streaming bronze, interactive gold, interactive silver, etc.) FIG. 6 shows blocking rate values, and supports editing/changing to requested new values for the blocking rates; similarly, dropping rates and demand values are presented, and dropping rates edited.

The requested new values for the blocking and dropping rates, serve as relative priorities. This is due to the fact lower values for blocking and/or dropping rates result in higher service levels, and higher relative portion of cell resources allocated to the requisite service classes, comparing with other service classes of the same service type and higher values of blocking and dropping rates.

The dynamic resource manager 202 (FIG. 3) and the traffic manager 203 (FIG. 3) will attempt to achieve the requested blocking and dropping rates in the course of the operations of the system 100, or at least achieve blocking and dropping rates in proportion to the requested ones, based on the available cell resources and the magnitude of demand in the service classes, as detailed below.

For the purpose of editing/changing the blocking and dropping rates, the above GUI 550 can be controlled interactively, as for example, a user, typically a system administrator, can raise or lower the various outputted sublevels, as appearing on the GUI 550. This raising or lowering typically occurs by a mechanism, such as movable icon 560 (arrow, cursor or the like) on the GUI, controllable by a pointing device (e.g., a mouse) allowing for sublevel changing, which in turn interpreted as input for requested new levels.

This administrator's changed values, from the aforementioned raising or lowering, as through the aforementioned processes, results in input, that is received by the system, at block 507. This input is submitted to the system, typically when an area 564 noted as “SUBMIT CHANGES” is activated, typically by the pointing device. This input is typically in the form of values for the service class “j”, with the requested new dropping rate, expressed as kⱼ^{new}, and the requested new blocking rate, expressed as bⱼ^{new}.

The desired changes having been inputted into the system, the system now analyzes these changes to see if they can be performed on the system, at block 509. In this block 509, the process involves, estimating expected results of these inputted changes on the system (that is, an estimation for the expected trends of the actual blocking and dropping rates, that will be measured during future operation of the system 100, following input of the new requested blocking and dropping rates). Output is then provided as to expected trends of changes in actual measured blocking and dropping rates, that might result from the changes inputted at block 505. In some cases, there will be output warning that the inputted changes are not possible, and alternately, the system can be programmed to override these unacceptable/not possible changes.

The estimation process of block 509 includes calculating new estimated values of blocking and dropping rates per service class. This may be done, for example, as follows:

First, the process checks whether the inputted values of block 505 are within a pre-defined logical range. If any values are outside this range, the system outputs a warning, that typically appears on the GUI 550, and no further processing is performed here. This logical range is typically defined as the values inputted, including dropping rate, expressed as kⱼ^{new}, and a blocking rate, expressed as bⱼ^{new}, being non-negative and below 100%.

Second, if inputs are within the aforementioned logical range, the process estimates the effect of inputted changes upon the system. This is done in steps, typically including calculating the total amounts of the inputted changes, the administrator is trying to enforce on the system, expressed as Δ. This value Δ is estimated, according to the following formula:

Δ=dⱼ((bⱼ^{new}−bⱼ)+(kⱼ^{new}−kⱼ)). (5)

Second, the new estimated blocking and dropping rates are calculated based on this amount of change Δ, for each service class i, other than the ones for service class j. This can be achieved, for example, according to the following formulas:

$$\begin{matrix}{b}_{i}^{new} = {b}_{i} \cdot \frac{{d}_{i} + \frac{Δ}{P}}{{d}_{i}} & ( 6 ) \\ {k}_{i}^{new} = {k}_{i} \cdot \frac{{d}_{i} + \frac{Δ}{P}}{{d}_{i}} & ( 7 )\end{matrix}$$

where,

P is the number of service classes;

bᵢ^{new} is the new estimated blocking rate for service class i; and

kᵢ^{new} is the new estimated dropping rate for service class i.

As this calculation ends, the process continues at block 509, where the newly calculated blocking rates and dropping rates per service class, bᵢ^{new} and kᵢ^{new} respectively, are presented, as outputs. These outputs can typically be viewed in the form of a GUI, similar to the GUI 550, detailed above, when a pointing device accesses the area 578 on the GUI labeled “VIEW CHANGES”. This will generate the new GUI indicating the administrator's inputted changes, as processed in accordance with the above detailed steps.

Absent any input, such as that performed by a system administrator (as detailed above) received within a predetermined time, the process moves to block 511, where it ends. Otherwise, should input be received, as detailed above, the process returns to block 507.

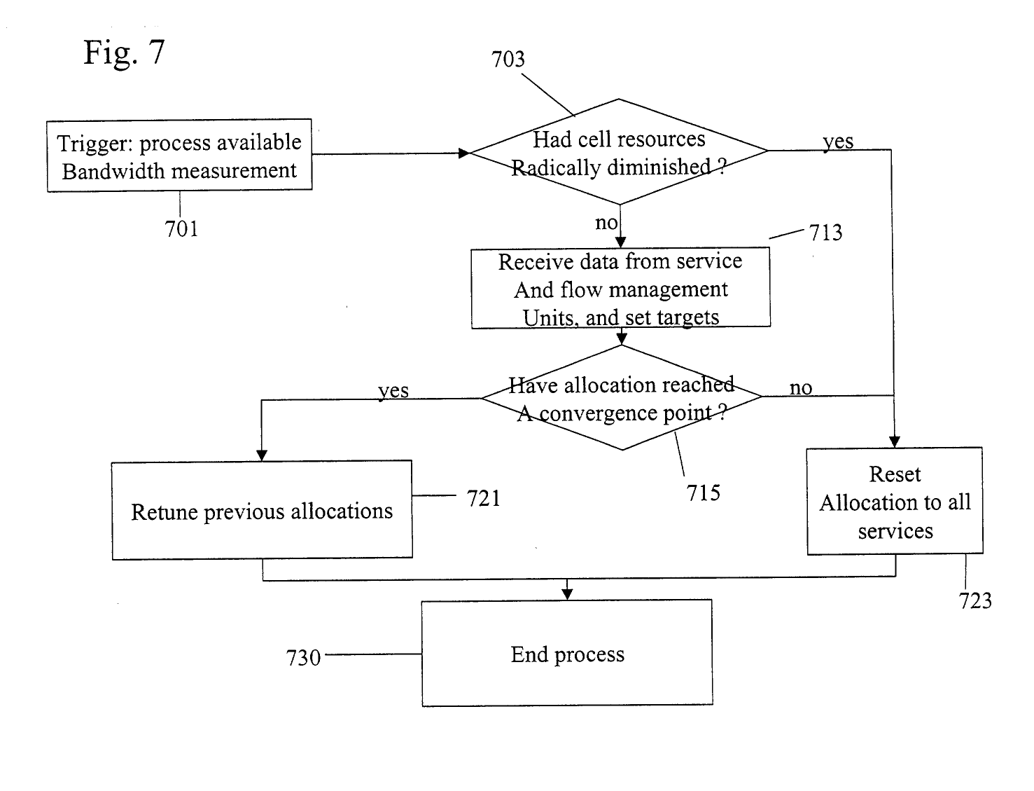

Turning back to FIG. 3, and also to FIG. 7, the process of dynamic resource management of block 220 now begins. The dynamic resource manager 220 (FIG. 3) and the traffic manager 230 (FIG. 3) attempt to achieve the requested blocking and dropping rates in the course of the operations of the system 100. An exemplary process of dynamic resource management will now be described by referring to FIG. 7. In this process bandwidth portions will be allocated to various service classes, aimed at satisfying the requested blocking and dropping rates for the requisite service classes, with these allocations implemented in the Flow/Traffic Management Unit, block 230 (FIG. 3).

Attention is directed now to FIG. 7, where there is shown an exemplary process of resource management and resource allocation per service class. The process is performed independently for each cell in the system, and is typically repeated for each cell in the system. The aim of this process is to allocate bandwidth per service class, trying to satisfy the requested blocking and dropping rates. This is done by means of two numbers that are calculated for each service class: 1. a guaranteed bandwidth portion, signifying the bandwidth the requisite service class is guaranteed to be allocated in case of demand; and 2. an overall bandwidth portion, signifying the maximal amount of bandwidth the requisite service class could utilize from the resources of the cell.

The process is initiated by a triggering event or trigger, at block 701. The triggering event may be a timing event from a counter of a clock, the default of which being every 5 seconds, or arrival of new available bandwidth measurements, or a combination of both. The default is a combination of both a timing event and the arrival of measurements that may trigger the process, this process initialized by the first of these two aforementioned events.

The cell bandwidth measurements result from monitoring the cellular side of the network 100a (FIG. 2). For example, the cell bandwidth can be estimated from the flow control messages sent along lines 136 between the core cellular network 120 and servers/control layers associated with the cells 126. these flow control messages typically deliver raw cell bandwidth information, that can be time averaged or median filtered to produce smooth cell bandwidth estimation.

After the process of monitoring and/or calculating the available cell bandwidth resources, C, is concluded operation moves to block 703, where it is checked whether cell resources have greatly diminished. This comparison takes into account previous guaranteed allocations per service class; if it is determined that previous guaranteed allocations cannot be met by existing resources, than it is decided that resources have diminished greatly. This can be done, for example, according to the following formula:

$$C < α \cdot {\sum }_{i = 1}^{P} {G}_{i}^{prev} \qquad ( 8 )$$

where,

C is the available cell bandwidth calculated at block 701;

α is a numerical constant, with a default of 1; and

Gᵢ^{prev} is the previous guaranteed allocation decided by the process for service class i at the previous cycle of operation; if no such value exists it is taken as 0.

If the condition of Formula (8) holds (is true), then resources have diminished radically, and operation passes to block 723 (detailed below), where allocations are reset. Alternatively, if the condition of Formula (8) does not hold (is false), then resources have not diminished greatly, and further inputs are required and useful for deciding allocations, so that operation is passed to block 713.

In block 713, input data is received from both the Flow Management Unit 105 (FIG. 2) and the Service Management Unit 101 (FIG. 2). These inputs are then utilized to determine a local blocking rate target and a local dropping rate target, on a per cell basis (each cell having its own service classes). The inputs sought are defined, as follows:

bᵢ^{tgt} is the global blocking rate target for service class i, as set by the Service Management Unit 101 (FIG. 2);

kᵢ^{tgt} is the global dropping rate target for service class i, as set by the Service Management Unit;

Bᵢ is the actual blocking rate for service class i, as measured by the Flow Management Unit 105 (FIG. 2);

Kᵢ is the actual dropping rate for service class i, as measured by the Flow Management Unit;

Dᵢ is the actual bits per second demand for service class i, as measured by the Flow Management Unit; and

Fᵢ is the actual average bits per second demand per flow for service class i, as measured by the Flow Management Unit.

The above global blocking and dropping targets are now processed, along with the demand and actual blocking and dropping rates above, to yield the local dropping and blocking targets. This may be done according to the following exemplary formulas:

$$\begin{matrix}{β}_{i} = {( \frac{{D}_{i}}{C} )}^{μ} \cdot {b}_{i}^{tgt} & ( 9 ) \\ {κ}_{i} = {( \frac{{D}_{i}}{C} )}^{μ} \cdot {k}_{i}^{tgt} & ( 10 )\end{matrix}$$

where,

βᵢ is the newly calculated blocking target for service class i of the requisite cell;

κᵢ is the newly calculated dropping target for service class i of the requisite cell; and

μ is a numerical constant with a default of 0.5.

The process now moves to block 715, where values corresponding to the previous allocations are checked against a reference value or values corresponding to a convergence point, to determine if a convergence point has been reached.

This checking against the value or values corresponding to a convergence point is performed, for example via the following exemplary conditions:

a) if no information concerning further allocations exists, then go to block 721

b) if the previous allocation was a resetting allocation, as per block 723, go to block 721,

c) if there exists a service class j for which either

Bⱼ>2βⱼ; or

Kⱼ>2κⱼ

go to block 723; and

if neither of (a) through (c) holds, go to block 721.

In the above,

Bⱼ is the blocking rate for service class j as measured by the Flow management unit 105;

βⱼ is the newly calculated blocking target for service class j of the requisite cell;

Kⱼ is the actual dropping rate for service class j, as measured by the flow management unit 105, and

κⱼ is the newly calculated dropping target for service class j of the requisite cell.

At block 721 previous allocations are retuned. This retuning is typically preformed in order to get as close as possible to the given local blocking and local dropping targets. For example, this might be done according to the following method.

First, at least one service class, for example one service class, with the highest blocking or dropping problem is isolated. The “deviation from target value”, δᵢ, of a service class i, is then determined to account for local blocking and dropping targets, as per the following exemplary formula:

δᵢ=Pᵢ·(max(Kᵢ−κᵢ, Bᵢ−βᵢ)) (11)

where,

Pᵢ is the priority level of service class i as defined by Service Management Unit 101 (FIG. 2).

Then the service class with highest δᵢ value is isolated, for example this service class is designated by j. If δⱼ≦0, then retuning does not occur (changes are not made), and the process moves to block 730, where it ends.

Alternatively, if δⱼ>0, retuning will occur. It will occur, for example, as follows (including the following formulas).

First, the bandwidth pool is defined according to the following formula:

$$Π = θ \cdot C - {\sum }_{i \neq j} {G}_{i}^{old} + {F}_{j} \qquad ( 12 )$$

where,

Gᵢ^{old} is the previous guaranteed allocation for service class i; and

θ is a numerical constant with a default of 1.

If

Π≧0, (13)

then the bandwidth pool is large enough, and it is set such that,

Gⱼ^{new}=Gⱼ^{old}+Fⱼ (14)

where,

Gⱼ^{new} is the new guaranteed bandwidth portion for the service class j.

Second, if Π<0, guaranteed bandwidth is reduced from portions of other service classes (those not service class j), until the pool Π is large enough, in the accordance with Formula (13). This is done according to the following: the service classes for which guaranteed allocation is positive, Gᵢ^{old}>0, are ordered by increasing order of their deviation from target values, δᵢ. Bandwidth is reduced from guaranteed allocations of service class(es) that have been isolated, in the order of their isolation. The amount of bandwidth reduces from these isolated service class(es), is added to the pool Π. This may be done according, for example, to the following formulas:

Gₘ^{new}=Gₘ^{old}−Fₘ (15)

Π=Π+Fₘ (16)

where

m is the next in the order of isolated service classes.

The pool Π is analyzed. If it is positive, formula (14) is performed for service class j. If it is negative, then the next in order of deviation from target value service class is selected, and formulas (15) and (16) are performed upon it and upon the pool.

Bandwidth is taken from guaranteed allocations in succession until the desired amount of BW is attained, or there is not any more bandwidth from these guaranteed allocations that can be taken. This can be done, for example, by repeating the sub process of formulas (12) through (16) until either of the following two conditions holds (is true):

enlarging Gⱼ^{new} in the sense of Formula (14) is impossible, because the pool Π is smaller than zero (formula (12) is false); or

there are no service classes remaining with positive guaranteed bandwidth portions (that is Gᵢ^{old}≦0 for any service class i).

At each of these cases, the process stops, where the adjusted guaranteed portions are kept in memory for delivery to Flow Management Unit 105 (FIG. 2).

With the above done, guaranteed bandwidth portions are determined for all service classes. The operation of block 721 concludes by setting overall bandwidth portions per service class. This may be achieved by setting each service class overall portion to be in a fixed proportion or within fixed differences from its already determined guaranteed portion. Another option is enlarging overall allocations depending on whether their requisite service classes did not yield positive dropping rates. Yet another alternative, which based on default, is setting all service classes overall allocations to be a fixed portion of the total amount of available resources, as in for example, the following formula:

Oᵢ^{new}=oᵢ^{overall}·C (17)

where,

Oᵢ^{new} is the newly calculated overall allocation for service class i;

oᵢ^{overall} is a numerical constant, with a default value of 1; and

C is the cell bandwidth resource calculated at block 701.

All these allocations being set, the operation of block 721 concludes, and the process moves to block 730, where it ends.

In block 723, the allocation is reset. This is aimed at generating a base allocation that can be subject to tuning (as per block 721 above). This resetting allocation might be achieved according to the following exemplary formulas:

Gᵢ^{new}=gᵢ^{reset}·C (18)

Oᵢ^{new}=oᵢ^{reset}·C (19)

where,

Gᵢ^{new} is the newly calculated guaranteed bandwidth portion to be allocated to service class i;

gᵢ^{reset} is a numerical constant for service class i, with a default of 0;

Oᵢ^{new} is the newly calculated overall bandwidth portion to be allocated to service class i; and

oᵢ^{reset} is a numerical constant for service class i, with a default of 1.

As a result of the sub-process of these formulas, a base allocation (also referred to as an allocation) has been made. The process now moves to block 730 where it ends.

At block 730, all the allocations per service classes are gathered, namely the guaranteed portion allocation and the overall portion allocation, and delivered, together with the available resources calculation, C, to the Flow Management Unit, 105 of FIG. 2.

Thus, the operation of dynamically allocating resources per service class of block 220 of FIG. 3 is completed, as its results are passed downward to the traffic management, or base, level 203.

Traffic management is necessarily a real-time continuous process, as traffic flows through the cell 126 in real time. The object of this process is to implement a control mechanism on the line 134 of FIG. 2, in order to apply the service level policy as designated within the Service Management Unit 101 (FIG. 2), in blocks 210 and 212, and later processed by the dynamic Resource Management Unit 103 (FIG. 2), at block 220.

The service level policy is applied by means of allocating resources such as bandwidth and delay, per cell, per service class and per flow. The resource allocation is typically based on the available cell bandwidth resources, C, and the guaranteed bandwidth and the overall bandwidth portions per service class, as calculated within the Resource Management Unit 103 (FIG. 2); the resource allocation is also typically based on the per-flow service level parameters and priority levels for each service class, as provisioned within the Service Management Unit 101 (FIG. 2).

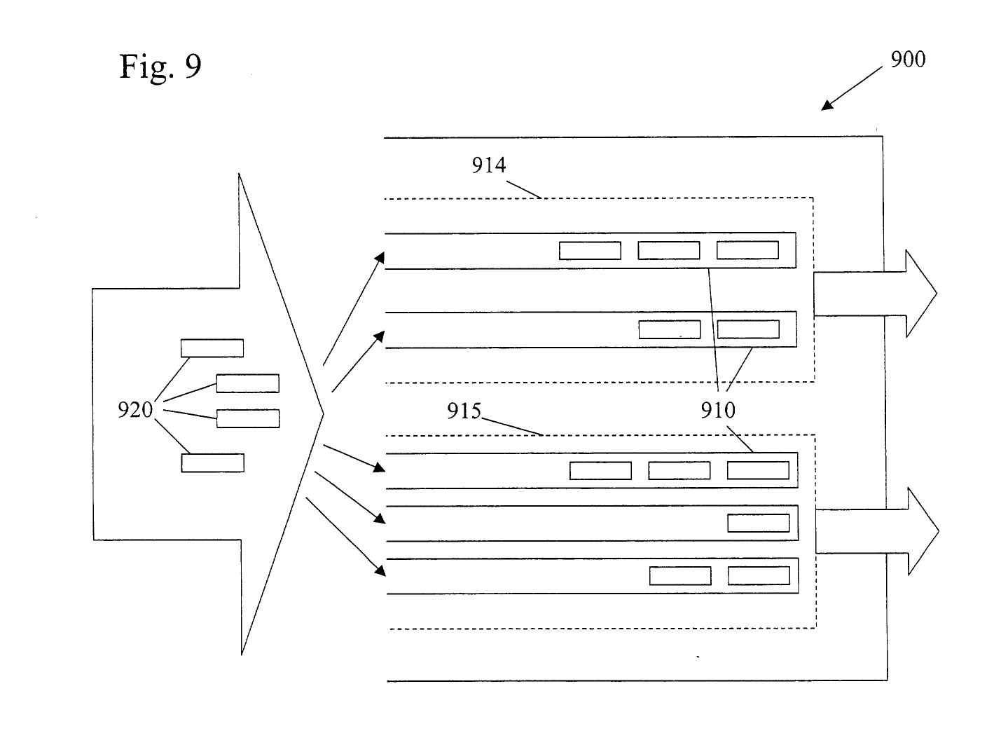

The process of flow management typically includes controlling a queuing device, such as the exemplary queuing device 900 shown in FIG. 9. The queuing device 900 sits on the line 134 (FIG. 2), to control the data packet traffic on this line. This process controls the specific data flows that are transmitted to each of the subscribers 130, the rate at which these flows are transmitted, and the times at which packets of these flows are released from the queuing devices. The process is typically preformed dynamically and on the fly, and controls specific parameters, detailed below, that control the queuing device 900.

The queuing device 900 includes queues 910 for each respective flow. These queues 910 are typically arranged in groups of one or more, in accordance with the various service classes. Here, for example, there are two service classes, 914 and 915. Each packet 920 arrives at the queuing device 900, and is sent to the requisite queue 910, having packets of the same flow. Association of the packets and the flow with the respective queue is based on the service classification rules, as provisioned within the Service Management Unit 101 (FIG. 2). If no such queue exists, a new queue is opened, and this non-corresponding packet of the new flow is sent to this newly opened queue. The queues 910 are typically first in first out (FIFO) queues, although more sophisticated queue structures may be used to support complex flows, which contain different sub-flows requiring different treatment in terms of delay and bandwidth.

The content of the packets may be stored directly within the queuing devices 900; alternatively, the queuing devices may be realized by logical/symbolic queues, storing the packets symbolically, for example by means of pointers or handles to the actual physical packet content storage.

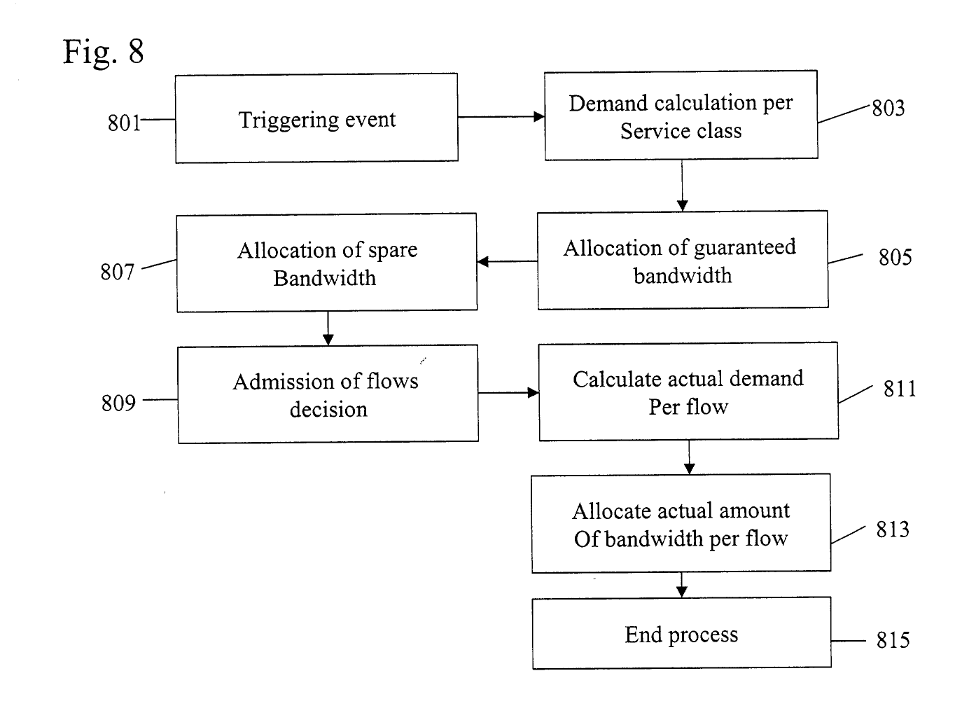

Referring also to FIG. 8, the process of bandwidth allocation is initiated by a triggering event or trigger, at block 801. The triggering event may be a timing event from a counter of a clock, the default of which being every 10 milliseconds, or arrival of new packets to the queuing device 900, as per arrow 922, or a combination of both. The default is a timing event with the aforementioned clock counter.

At block 803 the demand for each service class is calculated. This calculation is typically done by multiplying the number of flows within the service class by the typical bandwidth per flow of the requisite service class. The typical flow bandwidth for each service class may be pre-configured, for example by the administrator, or measured and averaged over long periods of the system 100 operations, or set to be equal to the minimum bandwidth per flow, as given by the Service Management Unit 101 (FIG. 2). The demand calculation may be done for example, by the following formula:

Dᵢ=Nᵢ·Fᵢ (20)

where,

Dᵢ is the demand calculated for service class i;

Nᵢ is the number of flows active in service class i, as calculated by counting the queues 910 for service class i; and

Fᵢ is the typical bandwidth per flow in service class i, such as the minimum bandwidth as set by the Service Management Unit 101 (FIG. 2), or as detailed above.

The process continues at block 805 where guaranteed bandwidth is allocated per service class, and the extra, or spare, bandwidth is collected. This can be done by allocating to each service class bandwidth up to the smallest between its demand and guaranteed bandwidth portion, as calculated by the dynamic Resource Management Unit 103 (FIG. 2) and detailed above. For example, this can be done according to the following formula:

Aᵢ=min(Dᵢ,Gᵢ) (21)

where,

Aᵢ is the guaranteed allocation to be calculated for service class i; and

Gᵢ is the guaranteed bandwidth portion for service class i, as calculated by the dynamic Resource Management Unit 103 (FIG. 2). After guaranteed bandwidth has been allocated, the spare bandwidth is calculated. This could be done in accordance with the following exemplary formula:

$$S = C - {\sum }_{i = 1}^{N} {A}_{i} \qquad ( 22 )$$

where,

S is the spare bandwidth to be calculated; and

C is the requisite cell bandwidth, as calculated by the dynamic Resource Management Unit 103 (FIG. 2) and detailed above; and

N is the number of service classes.

The process now continues to block 807 where the spare bandwidth is allocated to service classes according to their respective absolute priority levels and demand for this spare bandwidth. This is done by allocating bandwidth out of the spare bandwidth calculated above to service classes up to their respective demand, and by order of their respective absolute priority levels, as given by the Service Management Unit 101 (FIG. 2), and detailed above. This allocating of spare bandwidth continues until either of the following two conditions occurs: 1. the spare bandwidth is exhausted, that is there is no longer any spare bandwidth; or 2. all service classes have been allocated bandwidth equal to or larger than their respective demand.

The process moves to block 809 where flow admission decisions are taken. This process guarantees that each service class does not contain more flows that it can accommodate according to the bandwidth allocated to it at block 807. This is done according to the following sub-process.

First, it is checked whether new flows arriving at the queuing device 900 can be admitted for transmission. This can be done by admitting for transmission the maximal number of new flows Nᵢ^{new}, such that the following exemplary condition holds:

(Nᵢ^{current}+Nᵢ^{new})·Fᵢ<BWᵢ (23)

where,

Nᵢ^{current} is the number of flows of service class i that were already admitted previously; and

BWᵢ is the bandwidth allocation of service class i as calculated above.

Second, it is checked whether some existing flows should be dropped (killed) because of a drop in available resources. This can be done by dropping the minimal number of flows Nᵢ^{drop} in accordance with the following exemplary formula:

(Nᵢ^{current}−Nᵢ^{drop})·Fᵢ≦BWᵢ (24)

The process continues with block 811, where the actual momentary demand for bandwidth by each flow is calculated. For this purpose, the state of each flow is determined, and the actual momentary demand or bytes demand of each flow is calculated according to the flow state. The demand and the state are later utilized for setting transmission rate for each flow. The state of the flow could be, for example, either of the following three: 1. download state; 2. burst state; 3. idle state. In order to allocate actual bandwidth per flow, the state of each flow should be tracked. This can be done by going through the following exemplary conditions:

a flow which is of a rate type, can only be in a download state;

a flow is in idle state, if its requisite queue is empty (contains no bytes) at the time the process occurs;

a flow is in burst state, if its requisite queue contains less than a “burst size” amount of bytes (as defined by the Service Management Unit 101 (FIG. 2)), and in addition, it has been in an idle state for at least a predetermined amount of time, with a default of 5 seconds.

in all other conditions a flow is in download state.

The actual momentary demand or bytes demand for each flow is calculated by considering the actual amount of bytes waiting for transmission in the requisite flow queue. This could be done according to the following exemplary formula:

B^{dmnd}(i)=min(B^{q}(i),Fⱼ^{max}·T^{iteration}) (25)

where,

B^{dmnd}(i)—the bytes demand of flow i to be calculated;

B^{q}(i)—the amount of bytes in the requisite queue 910 of flow i, as measured by queuing device 900;

T^{iteration}—the clock count between two successive occurrences of the process, the default of which is 10 milliseconds.

Fⱼ^{max}—Maximum bandwidth per flow in partition j, as specified by the Service Management Unit 101 (FIG. 2).

The process continues at block 813 where actual amounts of bandwidth are allocated per queue 910 in queuing device 900, in order to facilitate packet transmissions from these queues 910 at the specified rates. This could be done according to the following two steps.

First, each queue and requisite flow is allocated a transmission rate according the bytes demand of its requisite flow, and up to the minimum bandwidth per flow as specified in the Service Management Unit 101 (FIG. 2). This could be done according to the following exemplary formula:

Tᵢ=min(B^{dmnd}(i),Fᵢ^{min}) (26)

where,

Tᵢ is the transmission rate to be calculated; and

Fᵢ^{min} is the minimum bandwidth per flow as determined in the Service Management Unit 101 (FIG. 2).

The second step of allocating transmission rates per flow consists of allocating the spare bandwidth of the cell. The spare bandwidth in this context is defined as the bandwidth not allocated in the first step of this block. It can be calculated according to the following exemplary formula:

$$\text{Spare} = C - {\sum }_{i = 1}^{M} {T}_{i} \qquad ( 27 )$$

where,

Spare is the spare bandwidth to be calculated; and

C is the cell bandwidth as calculated by the dynamic Resource Management Unit 103 (FIG. 2) and detailed above.

The spare bandwidth having been calculated, it is allocated to the queues 910 and requisite flows up to their bytes demand calculated above according, for example, to the following order: first, spare bandwidth is allocated to flows which are in burst state, as determined in block 811, by order of their priority absolute level, as determined by the Service Management Unit 101 (FIG. 2). Next spare bandwidth is allocated to all other flows, again by order of their requisite absolute priority levels, as set by the Service Management Unit 101. This allocation of spare bandwidth continues until either of the two following conditions holds: 1. spare bandwidth is exhausted; or 2. all flows in respective queues have been allocated bandwidth meeting their respective bytes demands.

As transmission bandwidth per flow and requisite queue has been set in block 813, the process continues to block 815, where it ends.

The processes detailed above, all or portions thereof, can also be embodied in programmable storage devices readable by a machine or the like, or other computer-usable storage medium, including magnetic, optical or semiconductor storage, or other source of electronic signals.

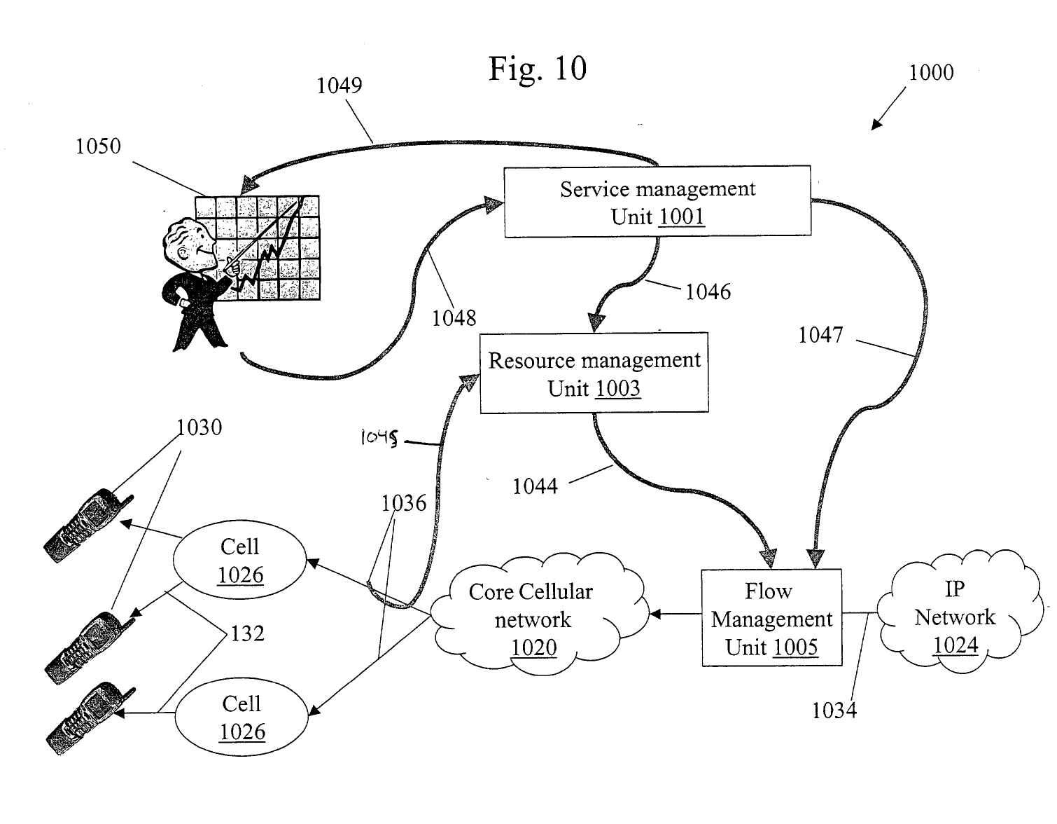

Attention is now directed to FIG. 10 showing an alternate embodiment of the present invention in a data network 1000. The data network 1000 is similar to data network 100 (FIG. 2), except where indicated. Similarities are indicated with component numbering that has been incremented by 900, such that similar components correspond in the “100” and “1000” series.

Here the system includes three units, 1001, 1003, and 1005, performing the invention. The units perform the invention in software, hardware, or combinations thereof. These units include: a Service Management Unit 1001, typically a server or the like, performing the Upper, or Service Management level 201 (FIG. 3) of the invention; a Resource Management Unit 1003, typically a server or the like, performing the Intermediate, or Resource Management Level 202 (FIG. 3) of the invention; and a Flow Management Unit 1005, typically a server, a switch, or the like, performing the Lower, or Flow Management Level 203 of the invention.

The Service Management Unit 1001 is configured for receiving inputted data from an external source, such as a system administrator 1050, as per arrows 1048 and 1049. It is also in communication with the Resource Management Unit 1003 and the Flow Management Unit 1005, as per arrows 1046 and 1047 respectively, representative, for example, of physical connections or lines.

The Resource Management Unit 1003 is also in connection with the Flow Management Unit 1005 as per arrow 1044, representative, for example, of a physical connection or line, and lines links or pipes 1036 as per arrow 1045, for monitoring available cell resources or cell capacity. While monitoring using along lines 1036 is shown, this is exemplary only, and monitoring can be performed within the cells 1026, within the core cellular network 1020, or any other place where measurements of cell capacity may be obtained continuously or “on the fly”.

The operation of the three units, 1001, 1003, and 1005, is as in FIG. 2, except that the Service Management Unit 1001 is in direct communication with the Flow Management Unit 1005, as per arrow 1047, rather than through the Resource Manage. The communications represented by arrow 1047 are in both directions, downward, from the service management unit 1001 to the flow management unit 1005, and upward, from the flow management unit 1001 to the service management unit 1005.

The communications delivered from the service management unit 1001 to the flow management unit 1005 typically include, for example, all service provisioning parameters, detailed above. The communications delivered from the flow management unit 1001 to the service management unit 1005 typically include statistics of demand, blocking rate and dropping rate per cell, as detailed above.

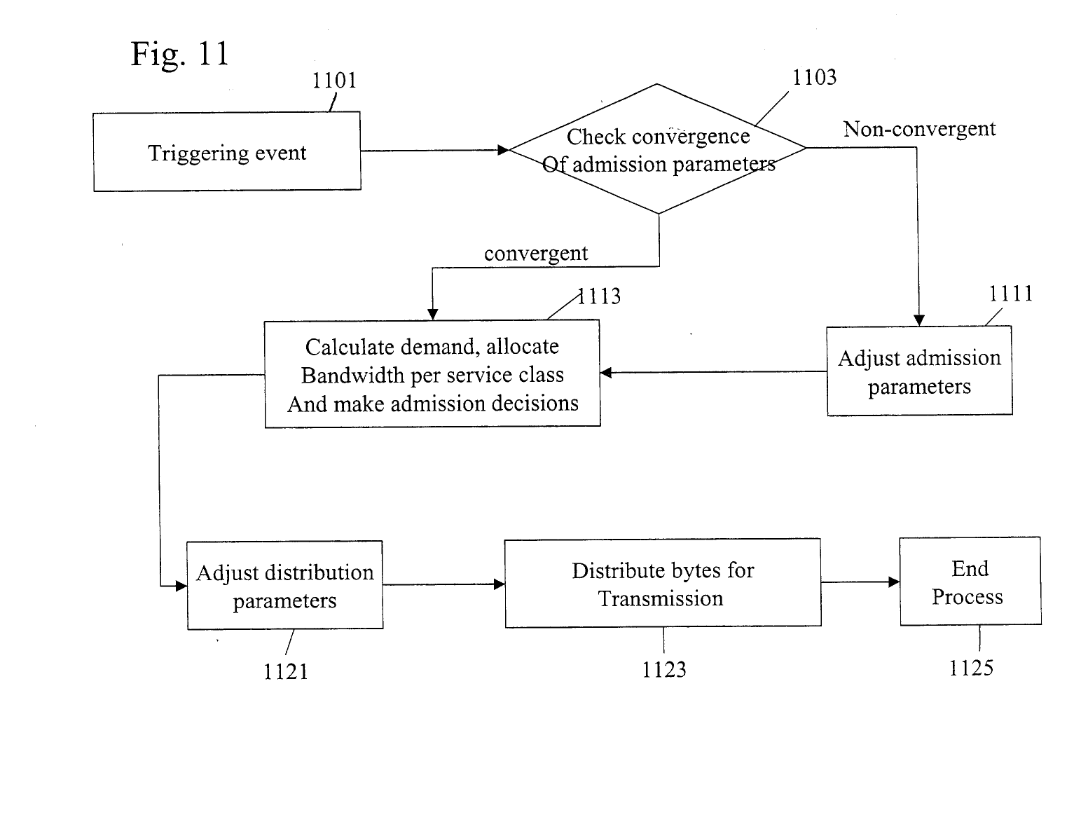

Attention is now directed to FIG. 11, showing an alternate process in accordance with the Lower, or Flow Management Level 203 (FIG. 3). The object of this process is to implement a control mechanism on the line 134 of FIG. 2, in order to withhold the service level policy as designated within the Service Management Unit 101 (FIG. 2), in blocks 210 and 212, and later processed by the dynamic Resource Management Unit 103 (FIG. 2), at block 220. This process is similar to the process of Flow Management as detailed above and in FIG. 8, except for the differences detailed below.

The process of flow management described here differs from that of FIG. 8 in that it allows for monitoring and controlling flow parameters on the fly, thus allowing variation on the pre-configuration of specific flow parameters at the Service Management Level 201 detailed above.

The process starts at block 1101, with a triggering event as in block 801 (FIG. 8). The default is a timing event from a counter of a clock, the default of which being every 10 milliseconds.

The process continues at block 1103, where the convergence of admission parameters is checked. This allows for adjusting the per-flow admission parameters, according to collected statistical measurements. The admission parameters checked include the minimum bandwidth per flow in a service class i, as set by the service management unit 101 (FIG. 2), designated by Fᵢ. This convergence checking can be done, for example, by means of checking the following relation for all service classes:

$$\vert {F}_{i} - \frac{{B}_{i}^{AvgDmnd}}{{T}^{iteration}} \vert > α \cdot max ( {F}_{i} , \frac{{B}_{i}^{AvgDmnd}}{{T}^{iteration}} ) \qquad ( 28 )$$

where,

B Bᵢ^{AvgDmnd} is the average demand for bytes for a flow in service class i, calculated by taking the average of the bytes demand for flow in service class i, B^{dmnd}(i), over all the flows in service class i. For the calculation of B^{dmnd}(i), see Formula (26) above;

T^{iteration} is the clock count between two successive occurrences of the process, the default of which is 10 milliseconds; and

α is a numerical constant, with a default of 0.5.

If the condition of formula (28) holds (is true) for at least one service class i, then it is decided that admission parameters do not converge, and the process turns to block 1111, where these parameters are adjusted. If the condition of formula (28) does not hold (is false) for all service classes, then admission parameters are convergent, and the process continues at block 1113.

At block 1111 adjustment of admission parameters is made. This allows for correction of flows admission parameters if it was decided in block 1103 that the pre-configured admission parameters have not converged. This adjustment can be done, for example, by applying the following formula all service classes i for which equation (28) does not hold:

$${F}_{i}^{new} = β \cdot {F}_{i} + ( 1 - β ) \frac{{B}_{i}^{AvgDmnd}}{{T}^{iteration}} \qquad ( 29 )$$

where,

Fᵢ^{new} is the new minimum bandwidth per flow in service class i to be calculated; and

β is a numerical constant in the range of 0 to 1, with a default of 0.5.

At block 1115 calculations of demand, allocations of guaranteed and spare bandwidth, and admission of flows decisions take place. This can be done, for example by following in order the operation of blocks 803, 805, 807 and 809 of FIG. 8. The only difference herein being using the new calculated minimum bandwidth Fᵢ^{new} instead of the minimum bandwidth per flow introduced above. This can be done by substituting Fᵢ^{new} for Fᵢ in Formulae (20) to (26) above.

At block 1121 an adjustment of distribution parameters takes place. This process allows for correction in the bytes allocated for transmission for each flow according to the requisite flow's demand. This allows the system to dynamically override the service management unit 101 (FIG. 2) configuration, in order to give more appropriate treatment to specific flows. This better treatment can be achieved by reassigning flows to new service classes, if their bandwidth requirements are closer to those accommodated by those other service classes. For example, this can be done as follows:

For each flow the arrival rate of bytes to the requisite flow queue is compared with all service classes per-flow QoS parameters. The flow is redirected to a queue defined by the service class whose QoS parameters are closest to the measured flow rate. Thus the flow can be reassigned to a new service class on the fly. For example, this comparison can be done by first defining a distance between the flow rate and the service class QoS parameters, according to the following formula:

$${δ}_{i} = \vert {B}_{f} - \frac{{F}_{i}^{min} + {F}_{i}^{max}}{2} \vert \qquad ( 30 )$$

where,

δᵢ is the distance of the flow from service class i—QoS parameters to be calculated;

B_{ƒ}is the measured rate of bytes arriving to the flow's requisite queue;

Fᵢ^{min} is the minimum bandwidth per flow as defined by the service management unit 101 (FIG. 2); and

Fᵢ^{max} is the maximum bandwidth per flow as defined by the service management unit 101 (FIG. 2).

Second, the flow will be reassigned to the service class yielding the lowest distance from its QoS parameters to the flow rate, δᵢ.

Another example of an adjustment process suitable for block 1121, is by adjusting distribution parameters. These distribution parameters typically include the minimum bandwidth per flow and the maximum bandwidth per flow. This can be done, for example, by setting the minimum bandwidth per flow in a service class to be an average of the minimum bandwidth per flow given by the service management unit, and between an average of all flows rates, B_{f}. In addition, the maximum bandwidth per flow in a service class can be set to be an average between the maximum bandwidth per flow given by the service management unit, and between an average of all flows rates, B_{ƒ}. Here an average can be arithmetic, geometric, a sliding window average, a sliding window exponential decay average, etc. The default average to be used is a simple arithmetic average.

The adjustment of bytes distribution done for all flows of the requisite cell ends the operation of block 1121.

The process continues at block 1123, where distribution of bytes for transmission takes place. This can be done as in blocks 811 (FIG. 8) and detailed above. As the operation of block 1123 concludes, the process continues to block 1125 where it ends.

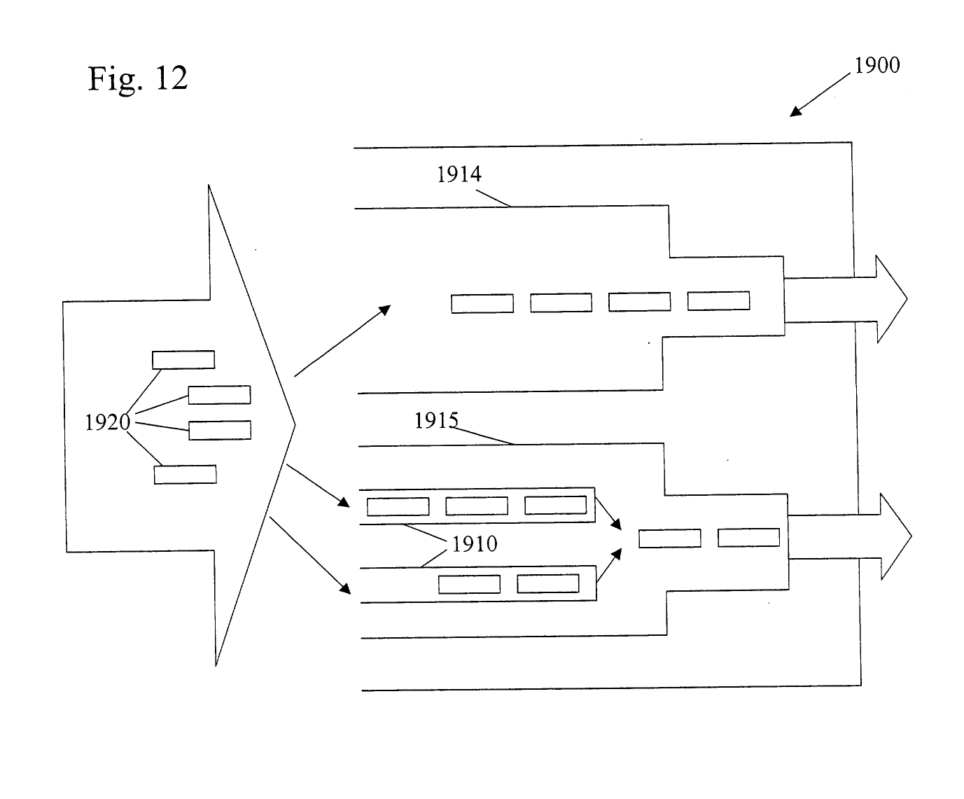

Attention is directed now to FIG. 12, showing a schematic of a queuing device 1900 used with an alternate embodiment of the invention. The queuing device 1900 is similar to queuing device 900 (FIG. 9), except where indicated. Similarities are indicated with component numbering that has been incremented by a 1000, such that similar components correspond in the “900” and “1900” series.

Here the queuing device contains two optional levels of queues: flow level queues 1910, and service class level queues 1914 and 1915. Each flow level queue 1910 contains packets of a single flow. Service class level queues contain packets of one or more flows, according to the number of flows in this service class.

Each packet 1920 arrives at the queuing device 1900, and is sent to a queue according the requisite flow service class. This queue can be of either of the aforementioned levels: a service-class level queue, as in queue 1914, or a flow level queue 1910. The packets 1920 in a flow level queue 1910 leave this queue 1910 to the requisite service class level queue 1915. Data packets 1920 leave the service level queues 1914 and 1915 for transmission. Though only two service level queues 1914 and 1915 and two flow level queues 1910 are shown, this is only exemplary, as there may be as many or as little queues of the two aforementioned levels.

In another alternate embodiment of the invention, the queuing device includes an optional connection proxy as follows. Referring to FIG. 9, the connection proxy governs the queues 910 and handles data traffic there through. This connection proxy may operate only upon queues dedicated to flows for which the governing data transmission protocol is reliable and connection oriented, for example TCP.

The connection proxy enables the system to further avoid cell congestion by adapting the behavior of connection-oriented flows to the specific cell available resources and requisite demand, thereby improving the network performance and the service level.

Connection-oriented and reliable transport protocols (“transport protocols”), such as TCP, adapt the transmission rate to the link throughput implicitly and continuously through “congestion avoidance” mechanism as follows: The transmitter side on these protocols increases the transmission rate until the point where congestion and packet loss occur, as signaled by lack of reception acknowledgment for certain transmitted packets within preset timeout, from the receiver side. Following congestion, the transmitter retransmits the lost packets and reduces the transmission rate below the point of congestion.

The congestion avoidance mechanism is inefficient in cellular networks, resulting in poor utilization of the available cell bandwidth due to the following reasons: (1) The cell throughput is extremely limited and highly inconsistent on one hand, while many users are sharing it on the other hand. Under such conditions, the transport-protocol rate control mechanism does not converge effectively, resulting in excessive packet loss and retransmission rate; (2) The transport-protocol rate control and congestion avoidance mechanisms fail to function effectively due to the high bit-error rate, as present on the air interface; this is since the packet loss due to air-interface bit-errors is interpreted as congestion by the transport-protocol mechanisms; (3) Large portions of the typical mobile data traffic are not subject to rate control, thereby causing interference to the rate control and congestion avoidance of the transport protocol.

The aforementioned embodiment overcomes the above limitations of transport protocols, improves the service level in terms of bandwidth and delay, and supports effective utilization of the cell available bandwidth. This is achieved through a mechanism that directly matches the transmission rate of the transport protocol to the explicitly allocated bandwidth for the respective flow, as allocated by the flow management unit 105 (FIG. 2), rather than implicitly adapt the transmission rate by means of the congestion avoidance mechanism.

The connection proxy overcomes transport protocol limitations as it functions as a client or host with respect to data packet traffic on the IP side, and as a server or host with respect to transmitted traffic on the cellular side.

The proxy typically holds the incoming packets on the downlink direction, from the IP side to the cellular side, and immediately acknowledges the IP side sender upon receiving the packets by itself, regardless of the packet reception on cellular side. The proxy then transmits the downlink packets to the cellular side according to the rate allocated to the requisite flow by the flow management unit 105 (FIG. 2). The proxy typically performs retransmissions on the cellular side locally, based on its internally saved downlink packets, rather than requiring the IP-side sender to retransmit lost packets on the air-interface.

With respect to downlink data packets of a flow, this means that the proxy keeps track of the state of incoming traffic from the IP side, such as the order of packets, missing data packets in said order, etc. All the data packets of the flow that reach the queue according to the flow state, for example, in the right order, are acknowledged to their respective sender, thus guaranteeing their delivery to the sender of the data packet flow. In this process, the proxy ensures that there are enough packets in the queue to enable future transmission of downlink packets to the cellular side. This can be done, for example, by sending the server directives as to whether to transmit to the requisite flow queue or not: if the queue is more then, for example, two thirds full (out of its maximal size), the proxy sends the server a directive to withhold or pause transmission until further notice. For example, in the case of TCP, this directive could be implemented by advertising a zero client window. When the queue empties, for example is less than one third full (out of its maximal size), the proxy sends a directive to resume transmission to the server. For example, in TCP this is achieved by advertising a non-zero client window, for example 2048 bytes.

With respect to the uplink direction, from the cellular side to the IP side, the proxy modifies the uplink packets as follows. The proxy has to override the transport protocol rate control and congestion avoidance mechanism, to ensure that the transmission rate from the queue 910 on the downlink direction is the rate allocated to the flow in the flow management unit 105 (FIG. 2). This can be done, for example, by overriding the downlink packet reception acknowledgments sent within uplink packets from the cellular side, and replace them with local acknowledgments that are sent within uplink packets, immediately upon receiving the downlink packets by the proxy itself. Since the resource management unit 103 and the flow management unit 105 (FIG. 2) allocate bandwidth per flow such that no cell congestion or other congestion within the cellular network occurs, the congestion avoidance mechanism on the downlink direction on the cellular side can be safely overridden, avoiding its inefficiencies with respect to cellular networks.

For example, connection-oriented protocols govern the rate of transmission according to the reception acknowledgments sent by the receiver for each packet it receives in order. Contemporary connection-oriented protocols, for example TCP, drastically lower transmission rate in case the rate in which acknowledgments are received falls. This is based on the assumption of contemporary connection oriented protocols that missed acknowledgements are caused by congestion. As by resource allocation this assumption is false, the proxy transmits data packets at the rate dictated to the queuing device 900 by the flow management unit.

However, the proxy maintains the reliability of the connection-oriented protocol by keeping a copy of each non-acknowledged packet. Thus non-acknowledged packets are retransmitted from the queue until they are acknowledged, ensuring reliable data delivery. This retransmission could be, for example, following a time out period defined to be twice the average measured round trip time from the connection proxy to the subscriber 130 (FIG. 2).

The proxy described above ensures that the downlink data rate, on the cellular side, equals to the bandwidth as allocated by the flow management unit 105 (FIG. 2) for the requisite flow. This refers to the gross rate, including packet retransmissions due to air-interface bit errors. Alternatively, the flow management unit 105 (FIG. 2) may be modified in a straightforward way to allocate variable gross bandwidth for a flow, based on available cell bandwidth, priorities and demand, such that the net rate allocation for the flow (excluding packet retransmission) is controlled directly. This may be done by considering only the first copy of each packet and excluding the retransmitted packets, when calculation the requisite flow's byte demand. For example, the net rate may be kept constant to ensure the service level on changing radio reception conditions and changing bit-error rates.

Another embodiment details the application of a process of dynamic resource management, that is an alternative to that described above and in FIG. 7. This alternate process goes about achieving blocking and dropping targets by dynamic allocations of bandwidth portion to service classes and flows, and can thus be used to replace the process described in FIG. 7 above, without additional modifications to the embodiment detailed above.

The process is comprised of obtaining available cell bandwidth data, and issuing instructions to the Flow Management Unit 105 of FIG. 2. These instructions typically include the rules to be applied for blocking and dropping of flows. The process can be implemented either within the Resource Management Unit 103 (FIG. 2) or within the Flow Management Unit 105 (FIG. 2). Applying the process within the Flow Management Unit 105 is the default.

This process begins with a triggering event followed by obtaining available cell bandwidth, as in block 701 of FIG. 7. Then, the process makes the following decisions, which are the outputted as follows:

For each new flow arriving at the Flow Management Unit 105 (FIG. 2), whether it should be blocked or admitted for transmission; and

For each flow already admitted for transmission at the Flow Management Unit 105 (FIG. 2), whether it should be dropped or its transmission should be continued.

These decisions can be taken according to the following exemplary stages:

If the sum of minimum bandwidth per flow (as defined in block 405 of FIG. 4) of existing flows is larger than available bandwidth (this sum referred to herein as “used bandwidth”) then the following actions are taken: a. drop flows in Last-In-First-Out (LIFO) order; and b. do not admit any new flow. Following the application of decisions a. and b. above, the process ends in this case.

Alternately, if the used bandwidth is smaller than, or equal to, available bandwidth, then new flows arriving at the Flow Management Unit 105 (FIG. 2) are checked, for example, by order of their arrival to determine whether they should be blocked or admitted for transmission. In this case, it is further determined if already existing flows should be dropped to allow the new flows admission to the cell. This is done as follows:

If the sum of used bandwidth and the minimum bandwidth of the new flow is smaller than, or equal to, available cell bandwidth, the flow should be admitted, and no existing flow should be dropped.

Alternately, if the sum of used bandwidth and the minimum bandwidth of the new flow is larger than available cell bandwidth, than it is checked whether there exists a service class whose dropping rate (as defined in FIG. 5 above) is smaller than its dropping target.

If there is a service class whose dropping rate (as defined in FIG. 5 above) is smaller than its dropping target, than the new flow is to be admitted, and flows from the service classes whose dropping rate targets were found to be larger than their respective targets are dropped. This dropping is done to ensure the available bandwidth portion to the new flow, and is typically by LIFO order. Alternately, if no service class with dropping rate smaller than dropping target is found, the new flow is to be blocked, and no existing flow is to be dropped.

The above decision process is now concluded, whereby this alternate process is ended.

The aforementioned methods, processes and portions thereof may be performed by hardware, software or combinations thereof. Additionally, the aforementioned methods, processes and/or portions thereof can also be embodied in programmable storage devices (for example, compact discs, magnetic or optical discs, etc.) readable by a machine or the like, or other computer-usable storage medium, including magnetic, optical or semiconductor storage, or other source of electronic signals.

The methods, systems, apparatus, and components thereof, disclosed herein are exemplary and have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in exemplary manners sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for managing data traffic in cellular networks, said cellular networks comprising at least one cell, comprising:
analyzing Quality of Service (QoS) parameters from at least one flow;
analyzing said at least one flow based on said QoS parameters to determine the minimum amount of resources for accommodating said at least one flow in said at least one cell;
monitoring said at least one cell for available resources;
determining the minimum amount of resources necessary for flows already accommodated in said at least one cell;
determining the amount of available resources for said at least one flow, based on said monitored resources of said at least one cell and said determined minimum amount of resources for said already accommodated flows in said at least one cell; and
if said determined minimum amount of resources for accommodating said at least one flow in said at least one cell is at least equal to said determined amount of available resources for accommodating said at least one flow in said at least one cell, admitting said at least one flow into said at least one cell.

2. The method of claim 1, wherein,
if said determined minimum amount of resources for accommodating said at least one flow in said at least one cell is not at least equal to said determined amount of available resources for accommodating said at least one flow in said at least one cell, blocking said at least one flow into said at least one cell.

3. The method of claim 1, wherein,
said at least one flow includes at least two flows,
if said determined minimum amount of resources for accommodating said at least two flows in said at least one cell is not at least equal to said determined amount of available resources for accommodating at least a single flow in said at least one cell, and
if said determined minimum amount of resources for accommodating at least one of said at least a single flow in said at least one cell is at least equal to said determined amount of available resources for accommodating said at least one flow in said at least one cell,
admitting said at least one flow into said at least one cell.

4. The method of claim 3, wherein said at least a single flow is selected from said at least two flows based on different priorities of the flows.

5. The method of claim 4, wherein said different priorities of the flows are determined by the priorities of the service classes associated therewith.

6. The method of claim 1, wherein, said analyzing QoS parameters of said at least one flow includes:
classifying said at least one flow into at least one service class; and
determining the QoS Parameters of said at least one flow based on said at least one service class.

7. The method of claim 6, wherein said QoS parameters include minimum bit rate.

8. The method of claim 6, wherein said QoS parameters include average bit rate.

9. The method of claim 6, wherein said QoS parameters include a maximum delay.

10. The method of claim 6, wherein said QoS parameters include dynamically changing QoS parameters based on the behavior of said at least one flow.

11. The method of claim 10, wherein said dynamically changing QoS parameters include different QoS parameters for different time periods of said at least one flow.

12. The method of claim 11, wherein said dynamically changing QoS parameters are selected from at least one of the group comprising: minimum rate, average rate, maximum delay.

13. The method of claim 11, wherein said time periods are selected from at least one of the group comprising: download period, interactive burst periods and idle periods.

14. The method of claim 1, wherein said monitoring at least one cell for available cell resources includes:
monitoring flow control signaling associated with said at least one cell.

15. The method of claim 1, wherein said flow control monitoring includes estimating the resources of said at least one cell.

16. The method of claim 1, wherein said determining the minimum amount of resources for accommodating said at least one flow in said at least one cell includes:
determining minimum bit rate based on a burst size and a maximum delay.

17. The method of claim 1, wherein said determined minimum amount of resources necessary for flows already accommodated in said at least one cell includes, determining the overall demand for each of the service classes of said at least one cell.

18. A server for managing data traffic in cellular networks comprising: a processor programmed to:
analyze Quality of Service (QoS) parameters from at least one flow;
analyze said at least one flow based on said QoS parameters to determine the minimum amount of resources for accommodating said at least one flow in said at least one cell;
monitor said at least one cell for available resources;
determine the minimum amount of resources necessary for flows already accommodated in said at least one cell;
determine the amount of available resources for said at least one flow, based on said monitored resources of said at least one cell and said determined minimum amount of resources for said already accommodated flows in said at least one cell; and
admit said at least one flow into said at least one cell if said determined minimum amount of resources for accommodating said at least one flow in said at least one cell is at least equal to said determined amount of available resources for accommodating said at least one flow in said at least one cell.

19. The server of claim 1, wherein said processor is additionally programmed, to:
block said at least one flow into said at least one cell, if said determined minimum amount of resources for accommodating said at least one flow in said at least one cell is not at least equal to said determined amount of available resources for accommodating said at least one flow in said at least one cell.

20. The server of claim 18, wherein said processor programmed to analyze said QoS parameters of said at least one flow is additionally programmed to:
classify said at least one flow into at least one service class; and
determine the QoS Parameters of said at least one flow based on said at least one service class.

21. The server of claim 18, wherein said processor programmed to monitor said at least one cell for available cell resources, is additionally programmed to:
monitor flow control signaling associated with said at least one cell.

22. The server of claim 18, wherein said processor programmed to monitor said at least one cell for available resources, is additionally programmed to, monitor flow control for estimating the resources of said at least one cell.

23. The server of claim 18, wherein said processor programmed to determine the minimum amount of resources for accommodating said at least one flow in said at least one cell, is additionally programmed to:
determine minimum bit rate based on a burst size and a maximum delay.

24. A programmable storage device readable by a machine, tangibly embodying a program of instructions executable by a machine to perform method steps for controlling traffic in a data network, said method steps selectively executed during the time when said program of instructions is executed on said machine, comprising:
analyzing Quality of Service (QoS) parameters from at least one flow;
analyzing said at least one flow based on said QoS parameters to determine the minimum amount of resources for accommodating said at least one flow in said at least one cell;
monitoring said at least one cell for available resources;
determining the minimum amount of resources necessary for flows already accommodated in said at least one cell; and
determining the amount of available resources for said at least one flow, based on said monitored resources of said at least one cell and said determined minimum amount of resources for said already accommodated flows in said at least one cell.

25. A method for managing resources in cellular networks comprising:
monitoring resources of at least one cell;
determining demand for resources for each of at least two service classes associated with said at least one cell; and
allocating resources for each of said service classes based on said monitored cell resources and said determined demand for resources.

26. The method of claim 25, wherein said monitoring resources of said at least one cell include:
monitoring flow control signaling associated with said at least one cell.

27. The method of claim 25, wherein said monitoring resources of said at least one cell includes, estimating the resources of said at least one cell.

28. The method of claim 25, wherein said determined demand for resources is in accordance with the relation:
D=N·B,
where,
D is said demand,
N is the number of flows admitted to the associated service class; and
B is the typical resources for a flow of the associated service class.

29. The method of claim 28, wherein said typical resources for a flow include, the minimum rate for a flow of said associated service class.

30. The method of claim 25, wherein said determining demand for resources includes determining the demand based on the dynamic behavior of each of said admitted flows.

31. The method of claim 30, wherein said determining demand for resources includes based on different parameters for different time periods for each of said admitted flows.

32. The method of claim 25, wherein said allocating resources includes determining QoS parameters for said at least one service class associated with said at least one cell, and determining the amount of resources allocated for said at least one service class based on said QoS parameters.

33. The method of claim 32, wherein said QoS Parameters for each of said service classes are selected from a group associated with each of said service classes, the group comprising:
minimum, or guaranteed, bandwidth per flow;
maximum, or overall, bandwidth per flow;
dropping or blocking, bandwidth per flow;
priority, or priority level, for all flows; and
combinations thereof.

34. A server for managing resources in cellular networks comprising:
a processor programmed to:
monitor resources of at least one cell;
determine demand for resources for each of at least two service classes associated with said at least one cell; and
allocate resources for each of said service classes based on said monitored cell resources and said determined demand for resources.

35. The server of claim 34, wherein said processor programmed to monitor resources of said at least one cell, is additionally programmed to:
monitor flow control signaling associated with said at least one cell.

36. The server of claim 35, wherein said processor programmed to monitor resources of said at least one cell, is additionally programmed to: estimate the resources of said at least one cell.

37. The server of claim 35, wherein said processor programmed to determine demand for resources, is additionally programmed to determine said demand based on the dynamic behavior of each of said admitted flows.

38. The server of claim 35, wherein said processor programmed to determine demand for resources, is additionally programmed to determine said demand based on different parameters for different time periods for each of said admitted flows.

39. The server of claim 35, wherein said processor programmed to allocate resources, is additionally programmed to: determine QoS parameters for said at least one service class associated with said at least one cell, and determine the amount of resources allocated for said at least one service class based on said QoS parameters.

40. A programmable storage device readable by a machine, tangibly embodying a program of instructions executable by a machine to perform method steps for controlling traffic in a data network, said method steps selectively executed during the time when said program of instructions is executed on said machine, comprising:
monitoring resources of at least one cell;
determining demand for resources for each of at least two service classes associated with said at least one cell; and
allocating resources for each of said service classes based on said monitored cell resources and said determined demand for resources.

41. A method for controlling Quality of Service (QoS) in cellular networks, comprising:
monitoring resources of at least one cell;
determining demand for resources for each of at least two service classes associated with said at least one cell; and
controlling the QoS of each of said service classes based on said monitored cell resources and said determined demand for resources.

42. The method of claim 41, wherein said monitoring resources of said at least one cell includes:
monitoring flow control signaling associated with said at least one cell.

43. The method of claim 41, wherein said monitoring resources of said at least one cell includes, estimating the resources of said at least one cell.

44. The method of claim 41, wherein said determined demand for resources is in accordance with the relation:
D=N·B,
where,
D is said demand,
N is the number of flows admitted to the associated service class; and
B is the typical resources for a flow of the associated service class.

45. The method of claim 44, wherein said typical resources for a flow include, the minimum rate for a flow of said associated service class.

46. The method of claim 41, wherein said determining demand for resources includes determining the demand based on the dynamic behavior of each of said admitted flows.

47. The method of claim 46, wherein said determining demand for resources includes determining said demand based on different parameters for different time periods for each of said admitted flows.

48. The method of claim 41, wherein said controlling QoS includes controlling parameters for said at least one service class associated with said at least one cell, by determining the amount of resources allocated for said at least one service class.

49. The method of claim 48, wherein said parameters for each of said service classes are selected from a group associated with each of said service classes, the group comprising:
dropping or blocking bandwidth per flow; and
combinations thereof.

50. A server for controlling Quality of Service (QoS) in cellular networks, comprising:
a processor programmed to:
monitor resources of at least one cell;
determine demand for resources for each of at least two service classes associated with said at least one cell; and
control the QoS of each of said service classes based on said monitored cell resources and said determined demand for resources.

51. The server of claim 50, wherein said processor programmed to monitor resources of said at least one cell, is additionally programmed to estimate the resources of said at least one cell.

52. The server of claim 50, wherein said processor programmed to determine demand for resources, is additionally programmed to determine the demand based on the dynamic behavior of each of said admitted flows.

53. The server of claim 52, wherein said processor programmed to determine demand for resources based on said dynamic behavior, is additionally programmed to: determine said demand based on different parameters for different time periods for each of said admitted flows.

54. The method of claim 50, wherein said processor programmed to control said QoS of each service class, is additionally programmed to control parameters for said at least one service class associated with said at least one cell, by determining the amount of resources allocated for said at least one service class.

55. A programmable storage device readable by a machine, tangibly embodying a program of instructions executable by a machine to perform method steps for controlling traffic in a data network, said method steps selectively executed during the time when said program of instructions is executed on said machine, comprising:
monitoring resources of at least one cell;
determining demand for resources for each of at least two service classes associated with said at least one cell; and
controlling the QoS of each of said service classes based on said monitored cell resources and said determined demand for resources.

56. A method for managing data traffic in cellular networks comprising:
analyzing Quality of Service (QoS) parameters for each of the flows accommodated by at least one cell;
determining the minimum amount of resources for keeping each flow accomodated by said at least one flow;
monitoring said at least one cell for available resources; and
determining if at least one specific flow from said flows accommodated by said at least one cell is dropped.

57. The method of claim 56, wherein said determining if said at least one specific flow is dropped, includes determining based on said determined minimum amount of resources, said monitored available resources and priorities of said flows.

58. The method of claim 56, wherein, said analyzing QoS parameters for each of said flows includes:
classifying each of said flows into at least one service class; and
determining the QoS Parameters of each of said flows based on said at least one service class.

59. The method of claim 58, wherein said QoS parameters include minimum bit rate.

60. The method of claim 58, wherein said QoS parameters include average bit rate.

61. The method of claim 58, wherein said QoS parameters include a maximum delay.

62. The method of claim 58, wherein said QoS parameters include dynamically changing QoS parameters based on the behavior of at least one of said flows.

63. The method of claim 62, wherein said dynamically changing QoS parameters include different QoS parameters for different time periods of said at least one flow.

64. The method of claim 63, wherein said dynamically changing QoS parameters are selected from at least one of the group comprising: minimum rate, average rate, maximum delay.

65. The method of claim 63, wherein said time periods are selected from at least one of the group comprising: download period, interactive burst periods and idle periods.

66. The method of claim 56, wherein said monitoring includes estimating the resources of said at least one cell.

67. The method of claim 57, wherein said monitored available cell resources of said at least one cell include:
monitoring flow control signaling associated with said at least one cell.

68. The method of claim 57, wherein said determined minimum amount of resources for keeping each of said flows accommodated by said at least one cell, includes:
determining minimum bit rate based on a burst size and a maximum delay.

69. A server for managing data traffic in cellular networks comprising:
a processor programmed to:
analyze Quality of Service (QoS) parameters for each of the flows accommodated by at least one cell;
determine the minimum amount of resources for keeping each flow accommodated by said at least one flow;
monitor said at least one cell for available resources; and
determine if at least one specific flow from said flows accommodated by said at least one cell is dropped.

70. The server of claim 69, wherein said processor programmed to determine if said at least one specific flow is dropped, is additionally programmed to determine based on said determined minimum amount of resources, said monitored available resources and priorities of said flows.

71. The server of claim 69, wherein said processor programmed to monitor said at least one cell for available resources, is additionally programmed to, estimate the resources of said at least one cell.

72. The server of claim 70, wherein said processor programmed to monitor said at least one cell for available cell resources, is additionally programmed to:
monitor flow control signaling associated with said at least one cell.

73. The server of claim 69, wherein said processor programmed to determine said minimum amount of resources for keeping each of said flows accommodated by said at least one cell, is additionally programmed to:
determine the minimum bit rate based on a burst size and a maximum delay.

74. A programmable storage device readable by a machine, tangibly embodying a program of instructions executable by a machine to perform method steps for controlling traffic in a data network, said method steps selectively executed during the time when said program of instructions is executed on said machine, comprising:
analyzing Quality of Service (QoS) parameters for each of the flows accommodated by at least one cell;
determining the minimum amount of resources for keeping each flow accommodated by said at least one flow;
monitoring said at least one cell for available resources; and
determining if at least one specific flow from said flows accommodated by said at least one cell is dropped.

75. A method for managing data traffic in cellular networks comprising:
analyzing Quality of Service (QoS) parameters for each of the flows admitted to at least one cell;
analyzing QoS for at least one flow waiting for admission to said at least one cell;
determining the minimum amount of resources to keep each admitted flow accommodated by said at least one cell;
determining the minimum amount of resources to admit said at least one flow waiting for admission to said at least one cell;
monitoring said at least one cell for available resources; and
determining if at least one specific flow from said flows accommodated by said at least one cell is dropped and said at least one flow waiting for admission is to be admitted.

76. The method of claim 75, wherein said determining if at least one specific flow from said flows accommodated by said at least one cell is dropped and said at least one flow waiting for admission is to be admitted, includes determining based on said determined minimum amount of resources, said monitored available resources and priorities of said flows.

77. A server for analyzing Quality of Service (QoS) parameters for each of the flows accommodated by at least one cell, comprising;
a processor programmed to:
determine the minimum amount of resources for keeping each flow accommodated by said at least one flow;
monitor said at least one cell for available resources; and
determine if at least one specific flow from said flows accommodated by said at least one cell is dropped.

78. The server of claim 77, wherein said processor programmed to determine if at least one specific flow from said flows accommodated by said at least one cell is dropped and said at least one flow waiting for admission is to be admitted, is additionally programmed to determine, based on said determined minimum amount of resources, said monitored available resources and priorities of said flows.

79. A programmable storage device readable by a machine, tangibly embodying a program of instructions executable by a machine to perform method steps for controlling traffic in a data network, said method steps selectively executed during the time when said program of instructions is executed on said machine, comprising:
analyzing Quality of Service (QoS) parameters for each of the flows admitted to at least one cell;
analyzing QoS for at least one flow waiting for admission to said at least one cell;
determining the minimum amount of resources to keep each admitted flow accommodated by said at least one cell;
determining the minimum amount of resources to admit said at least one flow waiting for admission to said at least one cell;
monitoring said at least one cell for available resources; and
determining if at least one specific flow from said flows accommodated by said at least one cell is dropped and said at least one flow waiting for admission is to be admitted.
